(19) United States
(12) Patent Application Publication
(10) Pub. No.: US 2010/0169879 A1
(43) Pub. Date: Jul. 1, 2010

(54) RESOURCE DISTRIBUTION SYSTEM AND METHOD

(75) Inventors: Iori TAKEDA, Takamatsu (JP); Koichi Hiramoto, Kawasaki (JP); Hitoshi Kamura, Takamatsu (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/576,456

(22) Filed: Oct. 9, 2009

(30) Foreign Application Priority Data
Dec. 25, 2008 (JP) 2008-331496

(51) Int. Cl. G06F 9/445; G06F 15/173

(52) U.S. Cl. 717/177; 709/226

(57) ABSTRACT

A resource distribution system and method that distributes a software resource to terminal apparatuses including receiving a distribution instruction having resource information indicating the software resource to be distributed to the terminal apparatuses and terminal information indicating the terminal apparatuses which are destinations of the resource and distributing the software resource indicated by the resource information to the specified terminal apparatuses. The system receives, from the terminal apparatuses to which the software resource has been distributed, control information used to control the distribution and determines whether distribution to other terminal apparatuses should be executed on the basis of the received control information.

### CROSS-REFERENCE TO RELATED APPLICATIONS

This application claims the benefit of priority from Japanese Patent Application No. 2008-331496 filed on Dec. 25, 2008, which is herein incorporated by reference in its entirety.

### BACKGROUND

1. Field

The present invention relates to a resource distribution system, a computer-readable recording medium having a resource distribution program, and a resource distribution method of distributing a computer resource, such as a program or data, to terminal apparatus(es) via a network.

2. Description of the Related Art

In a typical resource distribution system, a resource (a program or data) is simultaneously distributed to terminal apparatuses as distribution targets and the distributed resource is installed thereto, whereby laborsaving in maintenance related works on the respective terminal apparatuses is realized (see FIG. 28 in Japanese Unexamined Patent Application Publication No. 2002-16645).

### SUMMARY

According to an aspect of an embodiment described bellow, a resource distribution system and method distributes resource(s) such as a software resource to terminal apparatuses. The resource distribution system receives a distribution instruction including resource information indicating a software resource to be distributed to terminal apparatuses and terminal information indicating the terminal apparatuses which are destinations of the resource. The system specifies some of the terminal apparatuses indicated by the terminal information included in the distribution instruction, where the some of the terminal apparatuses are specified as targets of distribution executed on the basis of the resource information included in the distribution instruction. The system distributes the software resource indicated by the resource information included in the distribution instruction to the specified terminal apparatuses. The system receives, from the terminal apparatuses to which the software resource has been distributed, control information used to control the distribution of the software resource. The system makes a determination whether distribution to other terminal apparatuses can be executed on the basis of the received control information. The system specifies distribution targets among the terminal apparatuses indicated by the terminal information included in the distribution instruction when determining that distribution to other terminal apparatuses can be executed, and distributes the software resource to the specified terminal apparatuses.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a configuration of a system;

FIG. 2 illustrates a hardware configuration of a management apparatus;

FIG. 3 illustrates a configuration of a program executed by a management apparatus;

FIG. 4 illustrates a hardware configuration of a distribution apparatus;

FIG. 5 illustrates a configuration of a program executed by a distribution apparatus;

FIG. 6 illustrates a data structure and an example of content of a resource distribution DB (resource distribution information);

FIG. 7 illustrates a data structure and an example of content of the resource distribution DB (resource distribution information);

FIG. 8 illustrates a data structure and an example of content of an apparatus configuration DB (configuration information);

FIG. 9 illustrates a hardware configuration of a terminal apparatus;

FIG. 10 illustrates a configuration of a program executed by a terminal apparatus;

FIG. 11 illustrates a flow of a process in a system;

FIG. 12 illustrates a flow of a process in a system;

FIG. 13 illustrates an example of a screen of a distribution instruction inputting unit executed by a management apparatus;

FIG. 14 illustrates an example of a screen of an installation result inputting unit executed by a terminal apparatus;

FIG. 15 illustrates a data structure of a distribution instruction transmitted by a management apparatus;

FIG. 16 illustrates a data structure of an installation instruction transmitted by a distribution apparatus;

FIG. 17 illustrates a data structure of an installation result report transmitted by a terminal apparatus;

FIG. 18 illustrates a data structure of an installation result report transmitted by a distribution apparatus;

FIG. 19 illustrates a configuration of a program executed by a terminal apparatus according to an embodiment;

FIG. 20 illustrates a flow of a process in a system according to an embodiment;

FIG. 21 illustrates an example of a screen of a distribution target inputting unit executed by a terminal apparatus according to an embodiment;

FIG. 22 illustrates an example of a screen of a distribution instruction inputting unit executed by a management apparatus according to an embodiment;

FIG. 23 illustrates an example of a screen of a distribution instruction inputting unit executed by a management apparatus according to an embodiment;

FIG. 24 illustrates a data structure of candidate distribution targets transmitted by a distribution apparatus according to an embodiment;

FIG. 25 illustrates a data structure of a selection result report transmitted by a terminal apparatus according to an embodiment;

FIG. 26 illustrates a data structure of an installation instruction transmitted by a distribution apparatus according to an embodiment;

FIG. 27 illustrates a configuration of a program executed by a distribution apparatus according to an embodiment; and

FIG. 28 illustrates a configuration of a typical system.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Installation of a new resource may affect an existing function.

In an ordinary developing process, a regression test is performed to confirm that a malfunction of an existing function due to a developed item does not occur, in addition to a test of the developed item itself.

However, a sufficient time to perform the test is not necessarily acquired. Even if a sufficient time is acquired to perform the test, all failures are not necessarily found in advance.

For this reason, in the case where a new resource is simultaneously installed to all terminal apparatuses, an unexpected failure such as a malfunction of an existing function may occur, resulting in an increase in burden of maintenance related works.

Accordingly, the present invention includes providing a system and method capable of selecting a range of terminal apparatuses as targets of distribution of a software resource in stages when distributing the software resource to the terminal apparatuses. The disclosed system and method enable distribution of a resource to be adjusted or modified including based on control information resulting from distribution of the resource to at least some of the terminal apparatuses.

An embodiment described in the present application enables selecting a range of terminal apparatuses as targets of distribution of a software resource in stages on the basis of control information received from other terminal apparatuses to which the software resource has been installed when distributing the software resource to the terminal apparatuses, so that a load of maintenance works of the system can be reduced.

The system described in detail below is a resource distribution system that distributes a software resource to terminal apparatuses. The resource distribution system includes a distribution instruction receiving unit configured to receive a distribution instruction including resource information indicating a software resource to be distributed to terminal apparatuses and terminal information indicating the terminal apparatuses which are destinations of the resource, a distribution target specifying unit configured to specify at least some of the terminal apparatuses indicated by the terminal information included in the distribution instruction received by the distribution instruction receiving unit, at least some of the terminal apparatuses being specified as targets of distribution executed on the basis of the resource information included in the distribution instruction and a distribution executing unit configured to distribute the software resource indicated by the resource information included in the distribution instruction to the terminal apparatuses specified by the distribution target specifying unit.

The system includes a control information receiving unit configured to receive, from the terminal apparatuses to which the software resource has been distributed by the distribution executing unit, control information used to control the distribution of the software resource; and a distribution control unit configured to determine whether distribution to other terminal apparatuses can be executed on the basis of the received control information, allow the distribution target specifying unit to specify distribution targets among the terminal apparatuses indicated by the terminal information included in the distribution instruction when determined that distribution to other terminal apparatuses can be executed, and allow the distribution executing unit to distribute the software resource to the specified terminal apparatuses.

With this configuration, when a software resource is to be distributed to terminal apparatuses, a range of terminal apparatuses as targets of distribution of the software resource can be selected in stages on the basis of the control information received from other terminal apparatuses to which the software resource has been installed, so that a load of maintenance related works of the terminal apparatuses can be reduced.

In the above-described system, the control information receiving unit receives, when receiving the control information, authentication information indicating validity of the control information from the terminal apparatuses that transmit the control information. The distribution control unit makes the determination by using control information the validity of which has been verified on the basis of the received authentication information and does not use control information the validity of which has not been verified on the basis of the received authentication information.

With this configuration, the validity of the control information can be determined by using the authentication information received from the terminal apparatus, and the control information that is determined not to have validity can be eliminated.

That is, the terminal apparatus can be used by a general user other than a maintenance worker, administrator, or other user with a certain privilege of use. By eliminating an undesirable input by a user other than the maintenance worker, a malfunction due to distribution of a software resource can be effectively suppressed, so that a load of maintenance related works can be reduced.

In the above-described system, the distribution instruction received by the distribution instruction receiving unit includes authentication information that is used to verify the validity of the control information received by the control information receiving unit. The distribution control unit compares the authentication information received by the control information receiving unit with the authentication information received by the distribution instruction receiving unit, and determines that the control information has validity when a comparison result satisfies a predetermined condition.

With this configuration, the validity of the control information can be determined by using the authentication information received from the terminal apparatus, and the control information that is determined not to have validity can be eliminated.

That is, the terminal apparatus can be used by a general user other than a maintenance worker. By eliminating an undesirable input by a user other than the maintenance worker, a malfunction due to distribution of a software resource can be effectively suppressed, so that a load of maintenance works can be reduced.

In the above-described system, the control information received by the control information receiving unit includes an installation result including information about whether installation of the software resource has successfully been performed in the terminal apparatuses to which the software resource has been distributed by the distribution executing unit. When the number of pieces of the control information including an installation result indicating that installation of the resource has successfully been performed in the control information received by the control information receiving unit satisfies a predetermined condition, the distribution control unit determines that the software resource can be distributed to other terminal apparatuses.

With this configuration, when a software resource is to be distributed to terminal apparatuses, a range of terminal apparatuses as targets of distribution of the software resource can be selected in stages on the basis of the control information received from other terminal apparatuses to which the software resource has been-installed, so that a load of maintenance works of the terminal apparatuses can be reduced.

The resource distribution system includes an apparatus configuration DB configured to store configuration information that includes hardware configuration information indicating information of hardware provided in terminal apparatuses and software configuration information indicating information of software provided in the terminal apparatuses where the configuration information is associated with terminal IDs identifying the respective terminal apparatuses. The control information received by the control information receiving unit may include a terminal ID identifying the terminal apparatus that has transmitted the control information.

The distribution control unit obtains, from the apparatus configuration DB, the configuration information associated with the terminal ID that is the same as (matches) the terminal ID included in the control information received by the control information receiving unit, compares the configuration information associated with the terminal ID that is the same as the terminal ID included in the control information having an installation result indicating that installation of the software resource has not successfully been performed with the configuration information associated with the terminal ID that is the same as the terminal ID included in the control information having an installation result indicating that installation of the software resource has successfully been performed, compares configuration information associated with another terminal apparatus stored in the apparatus configuration DB with a different item which is different from an item in the configuration information associated with the terminal apparatus that has succeeded in installation of the software resource among items in the configuration information associated with the terminal apparatus that has not succeeded in installation of the software resource obtained from a comparison result, and eliminates the other terminal apparatus associated with the configuration information having an item that matches the different item from the targets of distribution executed by the distribution executing unit.

With this configuration, when a software resource is to be distributed to terminal apparatuses, a range of terminal apparatuses as targets of distribution of the software resource can be selected in stages on the basis of the control information received from other terminal apparatuses to which the software resource has been installed, so that a load of maintenance related works of the terminal apparatuses can be reduced.

The resource distribution system includes a candidate distribution target transmitting unit configured to transmit, to the terminal apparatuses to which the resource has been distributed by the distribution executing unit, candidate distribution targets that indicate terminal apparatuses to which the software resource has not been distributed by the distribution executing unit among the terminal apparatuses indicated by the terminal information included in the received distribution instruction. The control information received by the control information receiving unit includes a selection result indicating terminal apparatuses as present distribution targets among the candidate distribution targets. The distribution control unit allows the distribution executing unit to distribute the software resource to the terminal apparatuses indicated in the received selection result.

With this configuration, when a software resource is to be distributed to terminal apparatuses, a range of terminal apparatuses as targets of distribution of the software resource can be selected in stages on the basis of the control information received from other terminal apparatuses to which the software resource has been installed, so that a load of maintenance related works (tasks) of the terminal apparatuses can be reduced.

The program described in detail below is used in a terminal apparatus that installs a software resource distributed by a distribution apparatus and can be stored in a computer-readable medium, the program causing a computer functioning as the terminal apparatus to execute operations including receiving a software resource distributed by the distribution apparatus, executing installment of the received software resource, requesting an operator of the terminal apparatus to input information used to control distribution of the resource after completing the installment, and transmitting the input control information to the distribution apparatus.

With this configuration, after the software resource received from the distribution apparatus has been installed, an installation result of the software resource can be confirmed by operating the terminal apparatus, and a next distribution target can be indicated from the terminal apparatus. Accordingly, a load of maintenance related works can be reduced.

The program described in detail below causes the computer operating along the above-described program to execute requesting an input of information indicating whether installment of the resource has successfully been performed in the request to the operator of the terminal apparatus for inputting the control information.

With this configuration, after the software resource received from the distribution apparatus has been installed, an installation result of the software resource can be confirmed by operating the terminal apparatus, and a next distribution target can be indicated from the terminal apparatus. Accordingly, a load of maintenance related works can be reduced.

The program described in detail below causes the computer operating along the above-described program to execute receiving a list of terminal apparatuses from the distribution apparatus; and requesting the operator to select terminal apparatuses as next distribution targets from the received list in the request to the operator of the terminal apparatus for inputting the control information.

With this configuration, after the software resource received from the distribution apparatus has been installed, an installation result of the software resource can be confirmed by operating the terminal apparatus, and a next distribution target can be indicated from the terminal apparatus. Accordingly, a load of maintenance related works can be reduced.

The program described in detail below causes the computer operating along the above-described program to execute requesting the operator to input a password used for authentication in the distribution apparatus in the request to the operator of the terminal apparatus for inputting the control information.

With this configuration, the distribution apparatus is allowed to determined the validity of the control information by using the authentication information transmitted from the terminal apparatus, so that the control information that is determined not to have validity can be eliminated.

That is, the terminal apparatus can be used by a general user other than a maintenance worker. By eliminating an undesirable input by a user other than the maintenance worker, a malfunction due to distribution of a software resource can be effectively suppressed, so that a load of maintenance related works can be reduced.

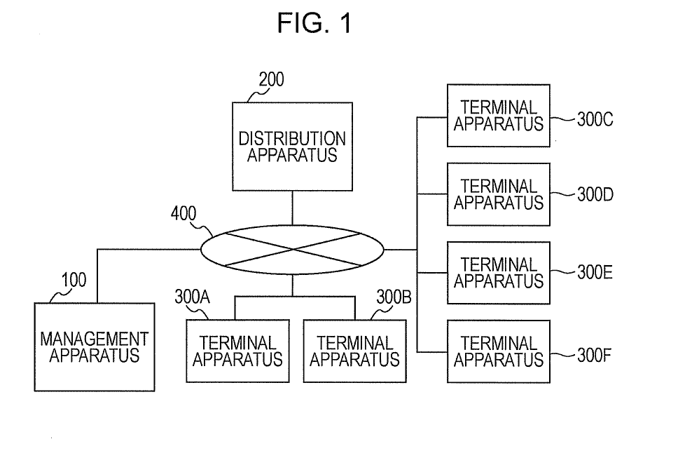

FIG. 1 illustrates a configuration of a system according to an embodiment of the present invention.

The system according to an embodiment of the present invention includes a management apparatus 100, a distribution apparatus 200, and terminal apparatuses 300.

The management apparatus 100 and the distribution apparatus 200 can communicate with each other via a network 400 by using a predetermined protocol, such as TCP/IP (Transmission Control Protocol/Internet Protocol) or UDP/IP (User Datagram Protocol/Internet Protocol), etc.

The distribution apparatus 200 and the plurality of terminal apparatuses 300 can communicate with each other via the network 400 by using a predetermined protocol, such as TCP/IP or UDP/IP, etc.

The management apparatus 100 may be placed, for example, in an information department that operates this system and is operated by an operator to register a resource to be installed to the terminal apparatuses 300 in the distribution apparatus 200.

The distribution apparatus 200 manages a resource registered in accordance with a registration request transmitted from the management apparatus 100 and distributes the resource to the terminal apparatuses 300 in accordance with settings made by the management apparatus 100.

Each of the terminal apparatuses 300 installs the resource distributed by the distribution apparatus 200 and then transmits a result of the installation process to the distribution apparatus 200.

In the above-described system configuration, an operator who operates the management apparatus 100 moves to the places where the respective terminal apparatuses 300 exist and operates the terminal apparatuses 300 as necessary after registering a resource in the distribution apparatus 200, in order to confirm an installation status of the resource in the terminal apparatuses 300.

For example, in the case where the maintenance worker, administrator, or other user with certain right(s) has recognized to some extent that no malfunction occurs in the terminal apparatuses 300 after a resource has been installed to the terminal apparatuses 300, the maintenance worker determines that installation of the resource has successfully been performed.

Then, the maintenance worker may have the necessity of providing instruction(s) to the distribution apparatus 200 to distribute the resource to other terminal apparatuses.

In such a case, the maintenance worker goes back to the place where the management apparatus 100 exists and operates the management apparatus 100 to input instruction(s) to the distribution apparatus 200 in a typical case.

For example, the maintenance worker performs an operation on the management apparatus 100 to allow the distribution apparatus 200 to distribute the resource to other terminal apparatuses.

This is because, in the case where a resource is to be distributed in stages by using a typical manner, where a resource is simultaneously distributed to set distribution targets, it has been necessary to set the terminal apparatuses to which the resource is to be distributed in each stage.

Furthermore, inputting instructions to the distribution apparatus 200 has typically been a function provided mainly by the management apparatus 100, and the terminal apparatuses 300 have not had a function of inputting instruction(s) to the distribution apparatus 200. Accordingly, the maintenance worker has typically had the necessity of operating the management apparatus 100 in each stage.

The system described in an embodiment performs a process procedure of determining whether installation of a resource to other terminal apparatuses 300 is to be performed on the basis of result(s) of installation of the resource to the terminal apparatuses 300, thereby enabling easy distribution in stages.

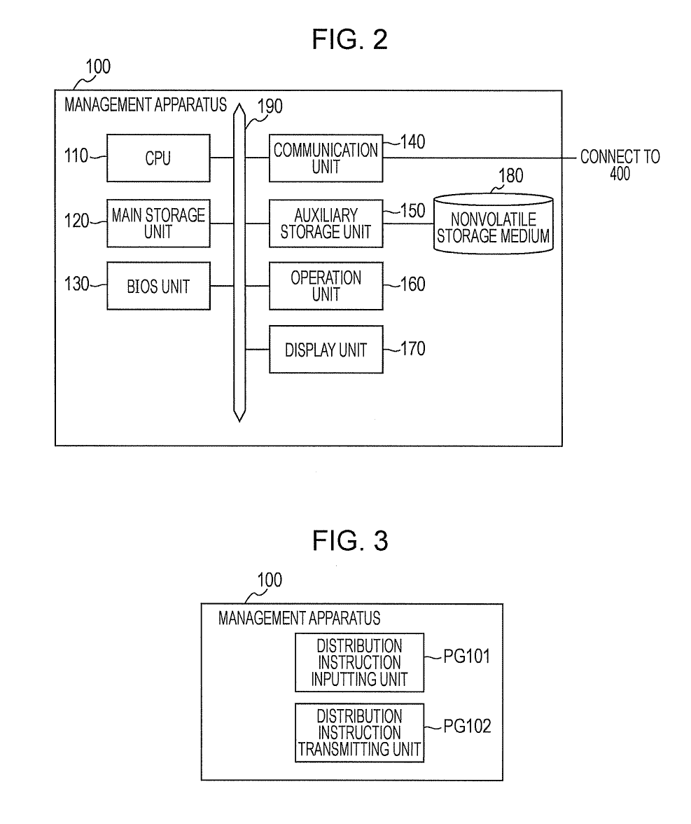

FIG. 2 illustrates a hardware configuration of a management apparatus such as the management apparatus 100.

The management apparatus 100 illustrated in FIG. 2 includes a CPU (Central Processing Unit) 110, a main storage unit 120, a BIOS (Basic Input Output System) unit 130, a communication unit 140, an auxiliary storage unit 150, an operation unit 160, a display unit 170, a nonvolatile storage medium 180, and a communication line 190.

The CPU 110 connects to the respective hardware units of the management apparatus 100 via the communication line 190 and realizes predetermined functions in accordance with a procedure of a program.

The CPU 110 includes, for example, an instruction register that temporarily stores instructions read from the main storage unit 120, an instruction decoder that decodes machine instructions (binary number) stored in the instruction register and that controls respective units of the management apparatus 100 in response to the instructions, an arithmetic logic unit that performs arithmetic operations, such as addition, subtraction, and comparison of values, under control by the instruction decoder, an accumulator that temporarily stores data to be operated and results of arithmetic operations, an address register that stores addresses of storage areas in the main storage unit 120 from/on which the CPU 110 reads/writes data; and a program counter that indicates the address of the storage area in the main storage unit storing an instruction to be executed next.

The main storage unit 120 stores data generated through execution by the CPU 110 and data read from the auxiliary storage unit 150.

For example, a semiconductor memory, such as an SDRAM (Synchronous Dynamic Random Access Memory) or an SRAM (Static Random Access Memory), can be used as the main storage unit 120.

The BIOS unit 130 stores a BIOS program that causes the CPU 110 to execute a process executed first at power-on of the management apparatus 100, such as initialization of the respective hardware units in the management apparatus 100.

For example, a nonvolatile semiconductor memory, such as a flash memory or an EEPROM (Electrically Erasable Programmable Read Only Memory), can be used as the BIOS unit 130.

The communication unit 140 transmits/receives signals to/from the distribution apparatus 200 via the network 400 in a wired or wireless manner.

The auxiliary storage unit 150 stores information in the nonvolatile storage medium 180 in response to a write instruction received from the CPU 110, and reads information stored in the nonvolatile storage medium 180 in response to a read instruction received from the CPU 110 and outputs the information.

For example, a magnetic recording device such as an HDD (Hard Disk Drive) or a nonvolatile semiconductor storage device such as an SSD (Solid State Disk) can be used as the auxiliary storage unit 150.

The nonvolatile storage medium 180 is a magnetic recording medium or a nonvolatile semiconductor memory, for example.

The nonvolatile storage medium 180 may be stored inside the auxiliary storage unit 150, or may be a portable nonvolatile storage medium that is inserted from the outside of the management apparatus 100.

The operation unit 160 accepts operation(s) performed by a user.

The operation unit 160 outputs signals according to operation(s) performed by the user to the CPU 110 via the communication line 190.

For example, a keyboard, a pointing device such as a mouse or a touch pad, and an input button can be used as the operation unit 160.

The display unit 170 allows a display device, such as a liquid crystal display device, to output information according to a control instruction provided from the CPU 110.

The display device may be integrated with the management apparatus 100 by being connected to the management apparatus 100 through the communication line included in the management apparatus 100, or may be connected to the management apparatus 100 by using a D-Sub (D-Subminiature) 15 pin cable or the like.

FIG. 3 illustrates a configuration of a program executed by the management apparatus 100.

The program illustrated in FIG. 3 includes instruction(s) causing a distribution instruction inputting unit PG101 and a distribution instruction transmitting unit PG102.

The distribution instruction inputting unit PG101 illustrated in FIG. 3 causes the CPU 110 to operate by serving as an element that accepts, for example, by using the operation unit 160, an input of a distribution instruction of instructing the distribution apparatus 200 to execute a process of distributing a software resource to the terminal apparatuses 300.

The distribution instruction transmitting unit PG102 illustrated in FIG. 3 causes the CPU 110 to operate by serving as an element that transmits, to the distribution apparatus 200 by using the communication unit 140, a distribution instruction of instructing the distribution apparatus 200 to execute a process of distributing a software resource to the terminal apparatuses 300.

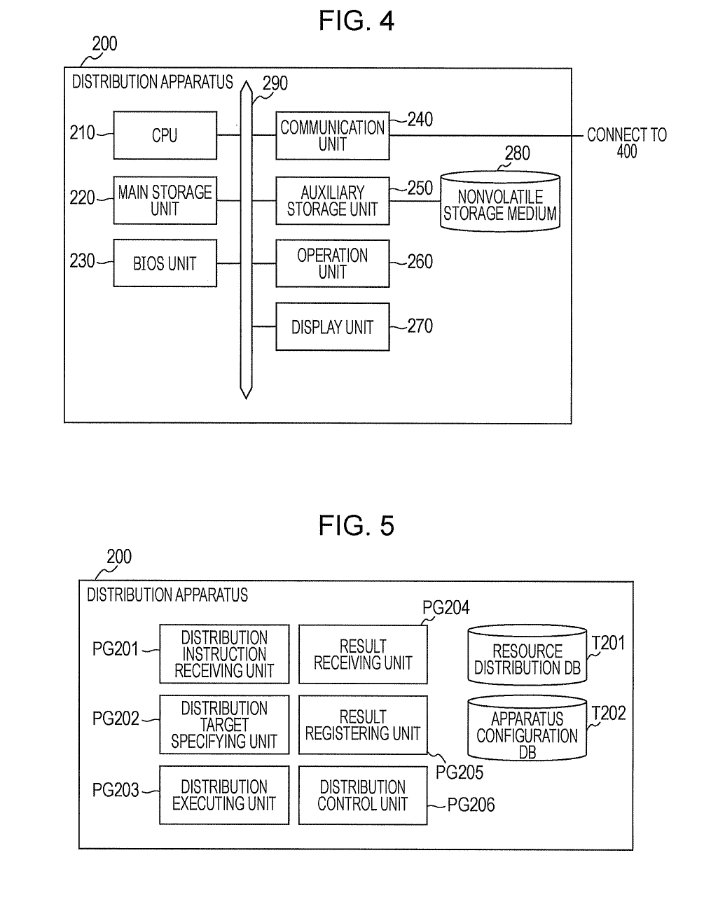

FIG. 4 illustrates a hardware configuration of the distribution apparatus 200.

The distribution apparatus 200 illustrated in FIG. 4 includes a CPU 210, a main storage unit 220, a BIOS unit 230, a communication unit 240, an auxiliary storage unit 250, an operation unit 260, a display unit 270, a nonvolatile storage medium 280, and a communication line 290.

The CPU 210 connects to respective hardware units of the distribution apparatus 200 via the communication line 290 and realizes predetermined function(s) in accordance with a procedure of a program.

The CPU 210 includes, for example, an instruction register that temporarily stores instructions read from the main storage unit 220; an instruction decoder that decodes machine instructions (binary number) stored in the instruction register and that controls the respective units of the distribution apparatus 200 in response to the instructions; an arithmetic logic unit that performs arithmetic operations, such as addition, subtraction, and comparison of values, under control by the instruction decoder; an accumulator that temporarily stores data to be operated and results of arithmetic operations; an address register that stores addresses of storage areas in the main storage unit 220 from/on which the CPU 210 reads/writes data; and a program counter that indicates the address of the storage area in the main storage unit storing an instruction to be executed next.

The main storage unit 220 stores data generated through execution by the CPU 210 and data read from the auxiliary storage unit 250.

For example, a semiconductor memory, such as an SDRAM or an SRAM, can be used as the main storage unit 220.

The BIOS unit 230 stores a BIOS program that causes the CPU 210 to execute a process executed first at power-on of the distribution apparatus 200, such as initialization of the respective hardware units in the distribution apparatus 200.

For example, a nonvolatile semiconductor memory, such as a flash memory or an EEPROM, can be used as the BIOS unit 230.

The communication unit 240 transmits/receives signals to/from the management apparatus 100 or the terminal apparatus 300 via the network 400 in a wired or wireless manner.

The auxiliary storage unit 250 stores information in the nonvolatile storage medium 280 in response to a write instruction received from the CPU 210, and reads information stored in the nonvolatile storage medium 280 in response to a read instruction received from the CPU 210 and outputs the information.

For example, a magnetic recording device such as an HDD or a nonvolatile semiconductor storage device such as an SSD can be used as the auxiliary storage unit 250.

The nonvolatile storage medium 280 is a magnetic recording medium or a nonvolatile semiconductor memory, for example.

The nonvolatile storage medium 280 may be stored inside the auxiliary storage unit 250, or may be a portable nonvolatile storage medium that is inserted from the outside of the distribution apparatus 200.

The operation unit 260 accepts operation(s) performed by a user.

The operation unit 260 outputs signals according to operation(s) performed by the user to the CPU 210 via the communication line 290.

For example, a keyboard, a pointing device such as a mouse or a touch pad, and an input button can be used as the operation unit 260.

The display unit 270 allows a display device, such as a liquid crystal display device, to output information according to a control instruction provided from the CPU 210.

The display device may be integrated with the distribution apparatus 200 by being connected to the distribution apparatus 200 through the communication line included in the distribution apparatus 200, or may be connected to the distribution apparatus 200 by using a D-Sub 15 pin cable or the like.

FIG. 5 illustrates a configuration of a program executed components of the distribution apparatus 200.

The configuration of the program illustrated in FIG. 5 includes causing a distribution instruction receiving unit PG201, a distribution target specifying unit PG202, a distribution executing unit PG203, a result receiving unit PG204, a result registering unit PG205, a distribution control unit PG206, a resource distribution DB (T201), and an apparatus configuration DB (T202).

The distribution instruction receiving unit PG201 illustrated in FIG. 5 causes the CPU 210 to operate by serving as an element that receives, from the management apparatus 100 by using the communication unit 240, a distribution instruction including resource information indicating a software resource to be distributed to the terminal apparatuses and terminal information indicating the terminal apparatuses as destinations of the resource.

The distribution target specifying unit PG202 illustrated in FIG. 5 causes the CPU 210 to operate by serving as an element that specifies some of the terminal apparatuses indicated by the terminal information included in the received distribution instruction, the some of the terminal apparatuses being specified as targets of a distributing process of the resource information included in the distribution instruction.

The distribution executing unit PG203 illustrated in FIG. 5 causes the CPU 210 to operate by serving as an element that distributes the software resource indicated by the resource information included in the distribution instruction to the terminal apparatuses specified by the distribution target specifying unit PG202.

The result receiving unit PG204 illustrated in FIG. 5 causes the CPU 210 to operate by serving as an element that receives, from the terminal apparatuses to which the software resource has been distributed, control information for controlling a distribution process of the software resource by using the communication unit 240.

The result registering unit PG205 illustrated in FIG. 5 causes the CPU 210 to operate by serving as an element that manages received control information by associating the control information with the distribution instruction.

The distribution control unit PG206 illustrated in FIG. 5 causes the CPU 210 to operate by serving as a element that determines whether a distribution range can be extended on the basis of the control information managed while being associated with the distribution instruction, that allows the distribution target specifying unit PG202 to specify distribution targets among the terminal apparatuses indicated by the terminal information included in the distribution instruction if it is determined that the distribution range can be extended, and that allows the distribution executing unit PG206 to distribute a software resource to the specified terminal apparatuses.

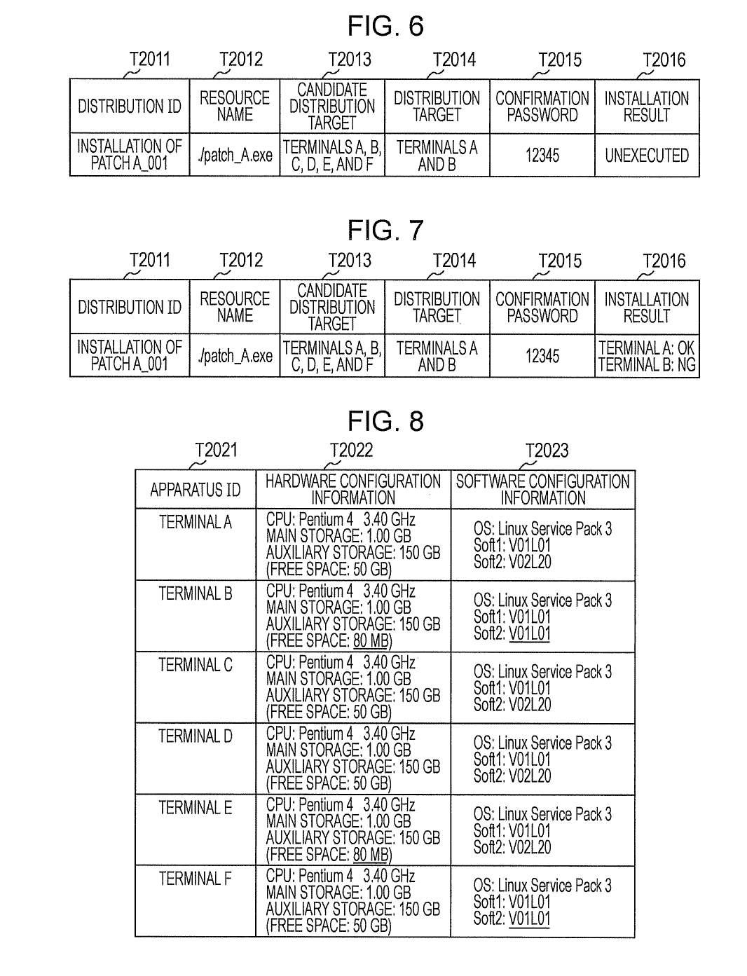

FIG. 6 illustrates a data structure of a database such as the resource distribution DB (T201).

The resource distribution DB (T201) illustrated in FIG. 6 includes a distribution ID (T2011), a resource name (T2012), a candidate distribution target (T2013), a distribution target (T2014), a confirmation password (T2015), and an installation result (T2016).

The distribution ID (T2011) illustrated in FIG. 6 indicates information identifying a distribution instruction received from the management apparatus 100.

The resource name (T2012) illustrated in FIG. 6 indicates information identifying a software resource indicated by a distribution instruction received from the management apparatus 100.

The candidate distribution target (T2013) illustrated in FIG. 6 indicates candidate distribution targets indicated by a distribution instruction received from the management apparatus 100.

The distribution target (T2014) illustrated in FIG. 6 indicates distribution targets in an initial distribution stage indicated by a distribution instruction received from the management apparatus 100 or terminal apparatuses to which a software resource has already been distributed.

The confirmation password (T2015) illustrated in FIG. 6 indicates authentication information used to authenticate the validity of control information received from the terminal apparatuses 300.

The installation result (T2016) illustrated in FIG. 6 indicates control information for controlling a distributing process of a software resource, received from the terminal apparatuses 300.

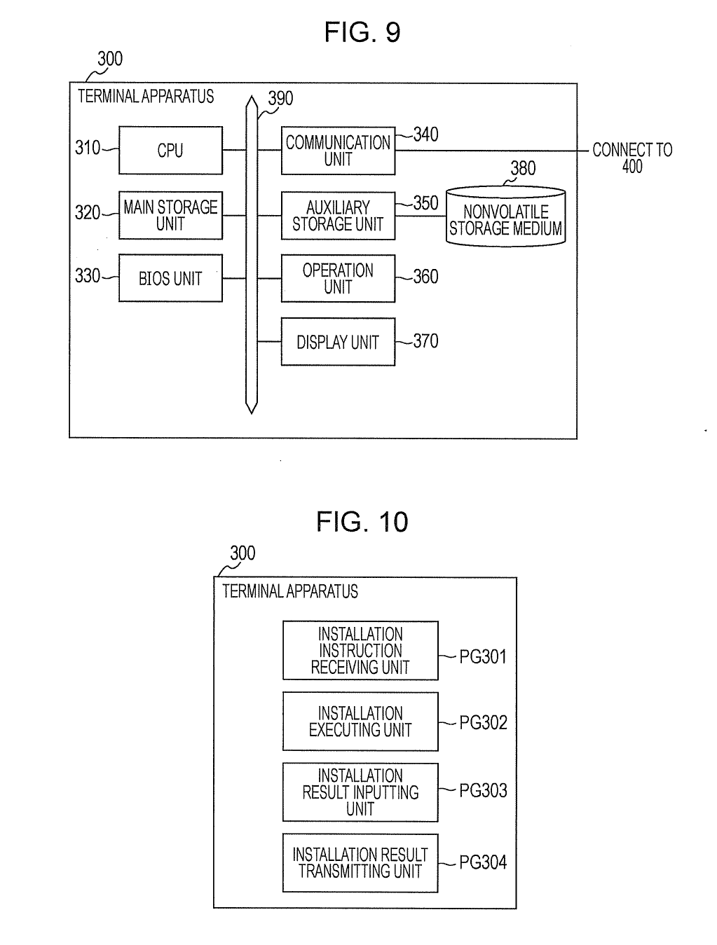

FIG. 9 illustrates a hardware configuration of a terminal apparatus such as the terminal apparatus 300.

The terminal apparatus 300 illustrated in FIG. 9 includes a CPU 310, a main storage unit 320, a BIOS unit 330, a communication unit 340, an auxiliary storage unit 350, an operation unit 360, a display unit 370, a nonvolatile storage medium 380, and a communication line 390.

The CPU 310 connects to respective hardware units of the terminal apparatus 300 via the communication line 390 and realizes predetermined functions in accordance with a procedure of a program.

The CPU 310 includes, for example, an instruction register that temporarily stores instructions read from the main storage unit 320; an instruction decoder that decodes machine instructions (binary number) stored in the instruction register and that controls the respective units of the terminal apparatus 300 in response to the instructions; an arithmetic logic unit that performs arithmetic operations, such as addition, subtraction, and comparison of values, under control by the instruction decoder; an accumulator that temporarily stores data to be operated and results of arithmetic operations; an address register that stores addresses of storage areas in the main storage unit 320 from/on which the CPU 310 reads/writes data; and a program counter that indicates the address of the storage area in the main storage unit storing an instruction to be executed next.

The main storage unit 320 stores data generated through execution by the CPU 310 and data read from the auxiliary storage unit 350.

For example, a semiconductor memory, such as an SDRAM or an SRAM, can be used as the main storage unit 320.

The BIOS unit 330 stores a BIOS program that causes the CPU 310 to execute a process executed first at power-on of the terminal apparatus 300, such as initialization of the respective hardware units in the terminal apparatus 300.

For example, a nonvolatile semiconductor memory, such as a flash memory or an EEPROM, can be used as the BIOS unit 330.

The communication unit 340 transmits/receives signals to/from the distribution apparatus 200 via the network 400 in a wired or wireless manner.

The auxiliary storage unit 350 stores information in the nonvolatile storage medium 380 in response to a write instruction received from the CPU 310, and reads information stored in the nonvolatile storage medium 380 in response to a read instruction received from the CPU 310 and outputs the information.

For example, a magnetic recording device such as an HDD or a nonvolatile semiconductor storage device such as an SSD can be used as the auxiliary storage unit 350.

The nonvolatile storage medium 380 is a magnetic recording medium or a nonvolatile semiconductor memory, for example.

The nonvolatile storage medium 380 may be stored inside the auxiliary storage unit 350, or may be a portable nonvolatile storage medium that is inserted from the outside of the terminal apparatus 300.

The operation unit 360 accepts operation(s) performed by a user.

The operation unit 360 outputs signals according to operations performed by the user to the CPU 310 via the communication line 390.

For example, a keyboard, a pointing device such as a mouse or a touch pad, and an input button can be used as the operation unit 360.

The display unit 370 allows a display device, such as a liquid crystal display device, to output information according to a control instruction provided from the CPU 310.

The display device may be integrated with the terminal apparatus 300 by being connected to the terminal apparatus 300 through the communication line included in the terminal apparatus 300, or may be connected to the terminal apparatus 300 by using a D-Sub 15 pin cable or the like.

FIG. 10 illustrates a configuration of a program causing an apparatus such as the terminal apparatus 300 to execute operation(s).

The program illustrated in FIG. 10 operates an installation instruction receiving unit PG301, an installation executing unit PG302, an installation result inputting unit PG303, and an installation result transmitting unit PG304.

The installation instruction receiving unit PG301 illustrated in FIG. 10 causes the CPU 310 to operate by serving as an element that receives a software resource transmitted from the distribution apparatus 200 by using the communication unit 340.

The installation executing unit PG302 illustrated in FIG. 10 causes the CPU 310 to operate by serving as an element that installs a software resource received from the distribution apparatus 200.

The installation result inputting unit PG303 illustrated in FIG. 10 causes the CPU 310 to operate by serving as an element that requests an operator of the terminal apparatus 300 to input control information controlling a process of distributing a software resource by the distribution apparatus 200, by using the operation unit 360 and the display unit 370 after installation has been completed.

The installation result transmitting unit PG304 illustrated in FIG. 10 causes the CPU 310 to operate by serving as an element that transmits input control information to the distribution apparatus 200 by using the communication unit 340.

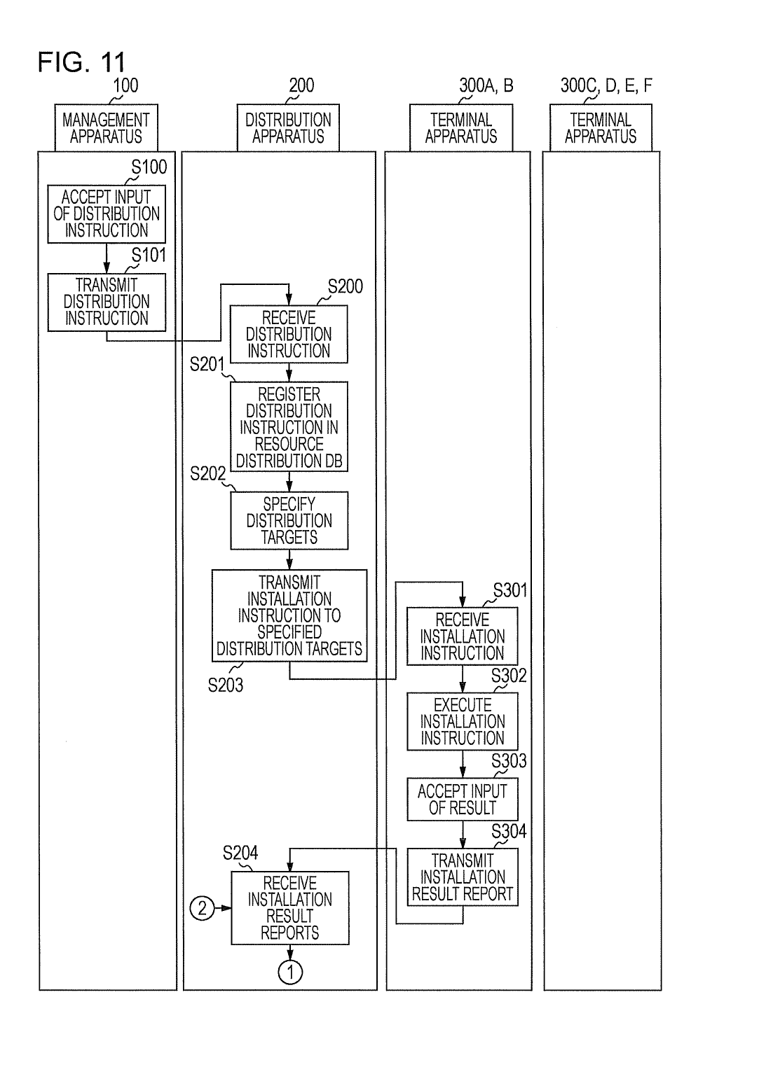

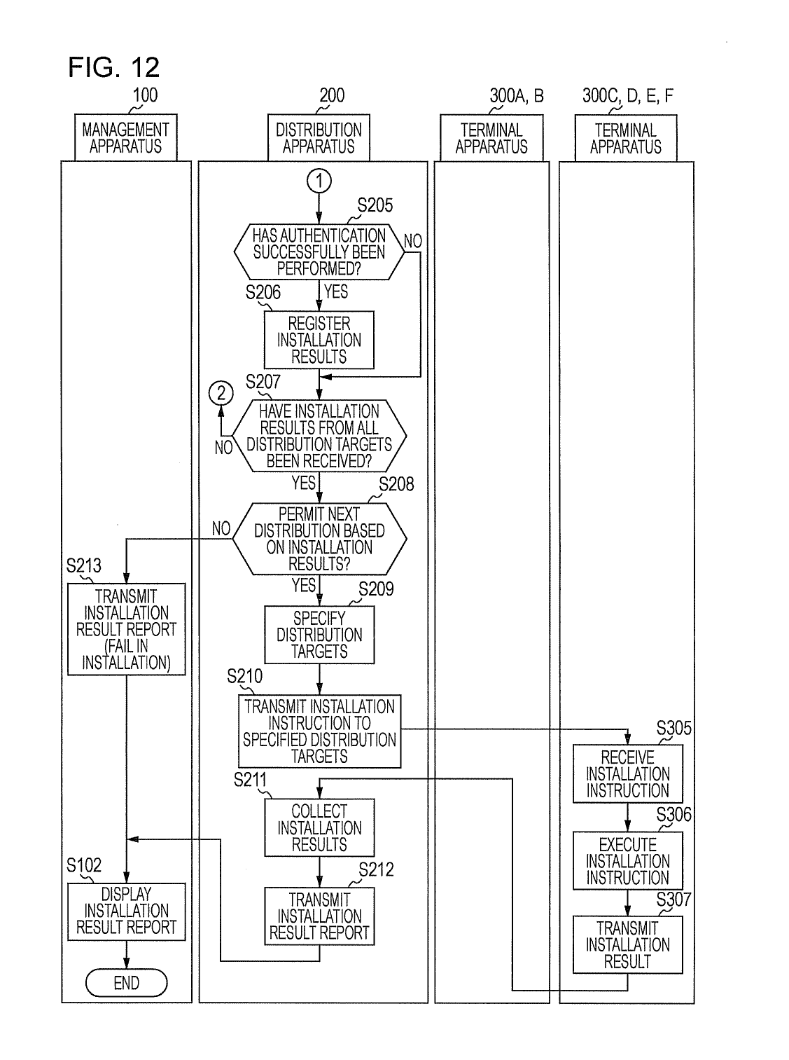

FIGS. 11 and 12 illustrate a flow of a process performed in the system.

First, the management apparatus 100 accepts an input operation of a distribution instruction (S100), whereby the process in the system starts.

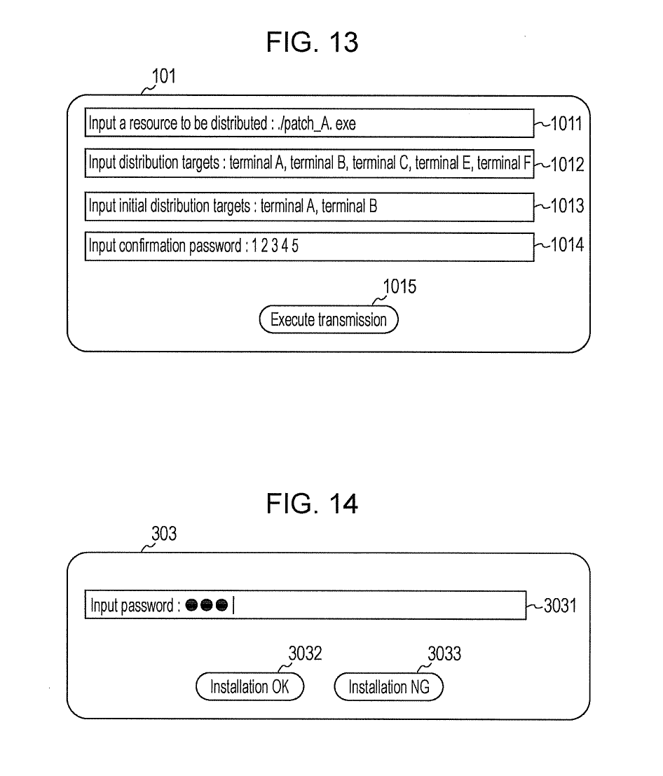

FIG. 13 illustrates an example of a screen of a distribution instruction inputting unit 101 that accepts an input operation of a distribution instruction in the management apparatus 100.

The example of the screen illustrated in FIG. 13 includes a distributed resource input field 1011, a distribution target input field 1012, an initial distribution target input field 1013, a confirmation password input field 1014, and a transmission execution button 1015 to provide instructions to transmit a distribution instruction.

The distributed resource input field 1011 accepts an input of information identifying the resource to be distributed.

In the example illustrated in FIG. 13, an execution file identified as “Ipatch_A.exe” is input as a resource to be distributed.

The distribution target input field 1012 accepts an input of information identifying terminal apparatuses as targets to which the resource is to be distributed.

For example, an IP address of the terminal apparatus or a MAC address set in the communication unit 340 in the terminal apparatus can be used as the information identifying the terminal apparatus.

In the example illustrated in FIG. 13, “terminal A” (terminal apparatus A), “terminal B” (terminal apparatus B), “terminal C” (terminal apparatus C), “terminal D” (terminal apparatus D), “terminal E” (terminal apparatus E), and “terminal F” (terminal apparatus F) are input as targets to which the resource is to be distributed.

The initial distribution target input filed 1013 accepts an input of information identifying the terminal apparatuses as distribution targets in an initial distribution stage (initial distribution targets) among the above-described distribution targets.

For example, an IP address of the terminal apparatus or a MAC address set in the communication unit 340 in the terminal apparatus can be used as the information identifying the terminal apparatus.

In the example illustrated in FIG. 13, “terminal A” (terminal apparatus A) and “terminal B” (terminal apparatus B) are input.

The confirmation password input field 1014 accepts an input of a password that is used to input an installation result in the terminal apparatus to which a resources has been installed.

In the example illustrated in FIG. 13, “12345” is input as the password.

The CPU 110 of the management apparatus 100 transmits a telegram indicating the distribution instruction (T101) to the distribution apparatus 200 by using the communication unit 140 on the basis of the above-described input information.

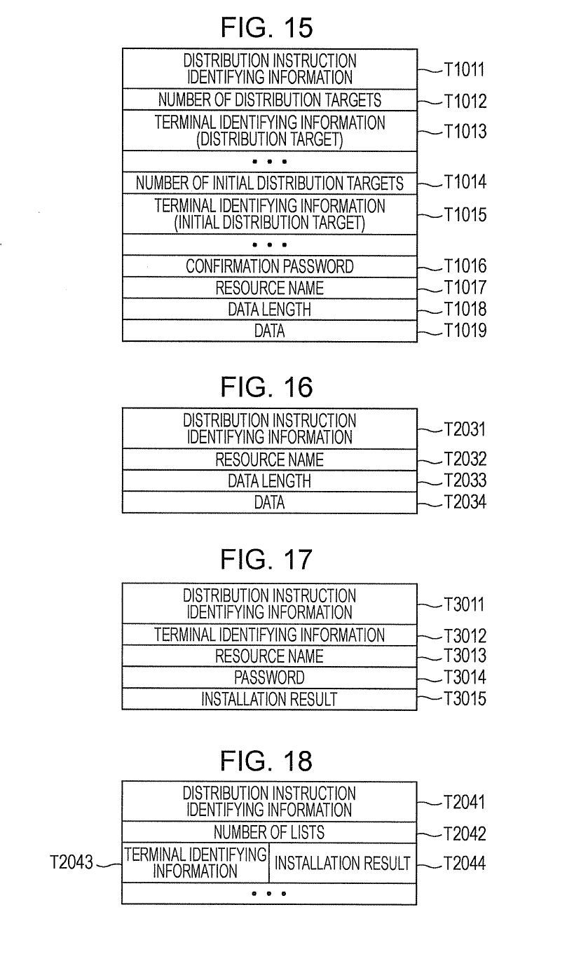

FIG. 15 illustrates a data structure of a distribution instruction such as instruction (T101) transmitted by the management apparatus 100.

The distribution instruction (T101) illustrated in FIG. 15 includes distribution instruction identifying information (T1011), a value indicating the number of distribution targets (T1012), pieces of terminal identifying information (T1013) the number of which corresponds to the number of distribution targets, a value indicating the number of initial distribution targets (T1014), pieces of terminal identifying information (T1015) the number of which corresponds to the number of initial distribution targets, a confirmation password (T1016), a resource name (T1017), a data length (T1018), and data (T1019). While particular information of the distribution instruction is illustrated in FIG. 15, the present invention is not limited to these.

The distribution instruction identifying information (T1011) illustrated in FIG. 15 is information identifying a distribution instruction transmitted from the management apparatus 100 to the distribution apparatus 200. For example, a character string of a predetermined length including alphameric characters can be used as the information.

Before transmitting a distribution instruction, the management apparatus 100 generates information identifying the distribution instruction and sets the information as the distribution instruction identifying information (T1011).

The number of distribution targets (T1012) illustrated in FIG. 15 indicates the number of terminal apparatuses input as distribution targets.

For example, the number of distribution targets (T1012) indicates the number of pieces of terminal identifying information input to the distribution target input field 1012 illustrated in FIG. 13.

The terminal identifying information (T1013) illustrated in FIG. 15 indicates information identifying a terminal apparatus input as a distribution target.

The distribution instruction includes pieces of the terminal identifying information (T1013) illustrated in FIG. 15 the number of which corresponds to the number of distribution targets (T1012).

A value corresponding to the terminal identifying information input to the distribution target input field 1012 illustrated in FIG. 13 is set to the terminal identifying information (T1013) illustrated in FIG. 15.

The number of initial distribution targets (T1014) illustrated in FIG. 15 indicates the number of terminal apparatuses input as initial distribution targets.

For example, the number of initial distribution targets (T1014) indicates the number of pieces of terminal identifying information input to the initial distribution target input field 1013 illustrated in FIG. 13.

The terminal identifying information (T1015) illustrated in FIG. 15 indicates information identifying a terminal apparatus input as an initial distribution target.

The distribution instruction includes pieces of the terminal identifying information (T1015) illustrated in FIG. 15 the number of which corresponds to the number of initial distribution targets (T1014).

A value corresponding to the terminal identifying information input to the initial distribution target input field 1013 illustrated in FIG. 13 is set to the terminal identifying information (T1015) illustrated in FIG. 15.

The confirmation password (T1016) illustrated in FIG. 15 indicates a password for being compared with a password used to input an installation result in a terminal apparatus to which a resource has been installed.

A value corresponding to the confirmation password input to the confirmation password input field 1014 illustrated in FIG. 13 is set as the confirmation password (T1016) illustrated in FIG. 15.

As an alternative to the confirmation password (T1016), an account ID on the system of a user who inputs a distribution instruction may be included in the distribution instruction.

In this case, an account ID on the system may be input by using a screen of the distribution instruction inputting unit illustrated in FIG. 13 or may be obtained by referring to login information or the like to an operating system.

The resource name (T1017) illustrated in FIG. 15 indicates information specifying a resource to be distributed.

For example, a value corresponding to the information input to the distributed resource input field 1011 illustrated in FIG. 13 is set.

The data length (T1018) illustrated in FIG. 15 indicates a data length of a distributed resource specified by the information input to the distributed resource input field 1011 illustrated in FIG. 13.

The data (T1019) illustrated in FIG. 15 indicates data of the distributed resource specified by the information input to the distributed resource input filed 1011 illustrated in FIG. 13.

The distribution apparatus 200 receives the distribution instruction transmitted from the management apparatus 100 connected via the network 400 (S200), and registers resource distribution information in the resource distribution DB (T201) on the basis of the received distribution instruction (S201).

FIG. 6 illustrates a data structure and an example of content of the resource distribution information registered in the resource distribution DB (T201).

The resource distribution information illustrated in FIG. 6 includes the distribution ID (T2011), the resource name (T2012), the candidate distribution target (T2013), the distribution object (T2014), the confirmation password (T2015), and the installation result (T2016).

The distribution ID (T2011) illustrated in FIG. 6 corresponds to the distribution instruction identifying information (T1011) indicated in the received distribution instruction.

In the example illustrated in FIG. 6, “installation of patch A_{—}001” is set as the distribution ID (T2011).

The resource name (T2012) illustrated in FIG. 6 corresponds to the resource name (T1017) indicated in the received distribution instruction.

The CPU 210 of the distribution apparatus 200 stores a resource file specified by the data length (T1018) and the data (T1019) included in the received distribution instruction in a storage area on the nonvolatile storage medium 280 specified by a resource name (T2012).

In the example illustrated in FIG. 6, “./patch_A.exe” is set as the resource name (T2012).

The candidate distribution target (T2013) illustrated in FIG. 6 corresponds to the pieces of the terminal identifying information (T1013) the number of which is indicated by the number of distribution targets (T1012) indicated in the received distribution instruction.

In the example illustrated in FIG. 6, “terminals A, B, C, D, E, and F”, i.e., the terminal apparatuses A, B, C, D, E, and F are registered as the candidate distribution target (T2013).

The distribution target (T2014) illustrated in FIG. 6 corresponds to the pieces of the terminal identifying information (T1015) the number of which is indicated by the number of initial distribution targets (T1014) indicated in the received distribution instruction.

In the example illustrated in FIG. 6, “terminals A and B”, i.e., the terminal apparatuses A and B, are registered as the distribution target (T2014).

The confirmation password (T2015) illustrated in FIG. 6 corresponds to the confirmation password (T1016) indicated in the received distribution instruction.

In the example illustrated in FIG. 6, “12345” is registered as the confirmation password (T2015).

Alternatively, the confirmation password (T2015) may be preset separately from the distribution instruction received from the management apparatus 100.

For example, a password can be registered by associating the password with an account ID on the system of a user who inputs the distribution instruction.

In this case, a value used as the confirmation password (T2015) can be specified by allowing the account ID of the user to be included in the distribution instruction received from the management apparatus 100.

By registering the password while associating the password with the account ID, the confirmation password input field 1014 can be omitted in the screen of the distribution instruction inputting unit illustrated in FIG. 13 executed by the management apparatus 100.

The installation result (T2016) illustrated in FIG. 6 indicates a result of installation of the resource to the terminal apparatuses indicated in the candidate distribution target (T2013) and the distribution target (T2014).

In the stage of operation S201, a corresponding value is not included in the received distribution instruction, and thus it is unnecessary that a value is set in the installation result (T2016) of the resource distribution information.

In the example illustrated in FIG. 6, “unexecuted” indicates that installation of the resource has not been executed.

Then, the CPU 210 of the distribution apparatus 200 specifies distribution targets in the initial distribution stage by referring to the distribution target (T2014) in the resource distribution information (S202).

In the example illustrated in FIG. 6, “terminal A” (terminal apparatus A) and “terminal B” (terminal apparatus B) are set as the distribution target (T2014).

The CPU 210 of the distribution apparatus 200 transmits an installation instruction to the specified distribution targets (S203).

FIG. 16 illustrates a data structure of an instruction such as an installation instruction (T203) transmitted from the distribution apparatus 200.

The installation instruction (T203) illustrated in FIG. 16 includes distribution instruction identifying information (T2031), a resource name (T2032), a data length (T2033), and data (T2034).

The distribution instruction identifying information (T2031) illustrated in FIG. 16 is information identifying the distribution instruction received from the management apparatus 100 and corresponds to the distribution ID (T2011) included in the resource distribution information registered in the resource distribution DB (T201), for example.

The resource name (T2032) illustrated in FIG. 16 corresponds to the resource name (T2012) included in the resource distribution information registered in the resource distribution DB (T201).

The data length (T2033) illustrated in FIG. 16 indicates the data length of the resource file stored in the storage area of the nonvolatile storage medium 280 specified by the resource name (T2012).

The data (T2034) illustrated in FIG. 16 indicates the data of the resource file stored in the storage area of the nonvolatile storage medium 280 (FIG. 4) specified by the resource name (T2012).

Each of the terminal apparatuses 300 receives the installation instruction transmitted from the distribution apparatus 200 connected via the network 400 (S301) and executes the received installation instruction (S302).

That is, the CPU 310 of the terminal apparatus 300 executes a process of installing the resource indicated by the received installation instruction.

After completing the installation process, the CPU 310 of the terminal apparatus 300 accepts an input of an installation result (S303).

FIG. 14 illustrates an example of a screen of an installation result inputting unit 303 executed by the terminal apparatus 300 that accepts an input of an installation result.

The example of the screen illustrated in FIG. 14 includes a password input field 3031, an installation OK button 3032 used to provide instructions to transmit a signal indicating that installation has successfully been performed, and an installation NG button 3033 used to provide instructions to transmit a signal indicating that installation has not successfully been performed.

In the case of having recognized to some extent that a malfunction does not occur in the terminal apparatus due to installation of the resource, a maintenance worker inputs the confirmation password to the password input field 3031 and presses the installation OK button 3032.

On the other hand, in the case of having recognized that a malfunction occurs in the terminal apparatus due to installation of the resource, the maintenance worker inputs the confirmation password to the password input field 3031 and presses the installation NG button 3033.

The CPU 310 of the terminal apparatus 300 transmits the installation result (3032 or 3033) input in operation S303 together with the password input to the password input filed 3031 by using the communication unit 340 (S340).

FIG. 17 illustrates a data structure of an installation result report such as transmitted from the terminal apparatus 300.

The installation result report illustrated in FIG. 17 includes distribution instruction identifying information (T3011), terminal identifying information (T3012), a resource name (T3013), a password (T3014), and an installation result (T3015).

The distribution instruction identifying information (T3011) illustrated in FIG. 17 corresponds to the distribution instruction identifying information (T2031) indicated in the installation instruction received in operation S301.

The terminal identifying information (T3012) illustrated in FIG. 17 is information identifying the terminal apparatus that transmits the installation result report and corresponds to the terminal identifying information registered in the candidate distribution target (T2013) or the distribution target (T2014) of the resource information registered in the resource distribution DB (T201) included in the distribution apparatus 200.

The CPU 310 of the terminal apparatus 300 can obtain the terminal identifying information preset in a predetermined storage area of the terminal apparatus 300 and set the terminal identifying information as the terminal identifying information (T3012) in the installation result report.

In the case where the terminal identifying information identifying a destination terminal apparatus is included in the installation instruction transmitted in operation S203, the CPU 310 of the terminal apparatus 300 can set the terminal identifying information included in the installation instruction received from the distribution apparatus 200 as the terminal identifying information (T3012) in the installation result report.

The resource name (T3013) illustrated in FIG. 17 corresponds to the resource name (T2032) indicated in the installation instruction received from the distribution apparatus 200 in operation S301.

The password (T3014) illustrated in FIG. 17 corresponds to the value input to the password input field (3031) illustrated in FIG. 14.

The installation result (T3015) illustrated in FIG. 17 corresponds to an operation result of the installation OK button (3032) or the installation NG button (3033) illustrated in FIG. 14.

That is, a press of the installation OK button (3032) illustrated in FIG. 14 causes information indicating that installation of the resource has successfully been performed to be set as the installation result (T3015).

On the other hand, a press of the installation NG button (3033) illustrated in FIG. 14 causes information indicating that installation of the resource has not successfully been performed to be set as the installation result (T3015).

The distribution apparatus 200 receives the installation result reports transmitted from the respective terminal apparatuses 300 connected via the network (S204) and executes an authentication process on the received installation result reports (S205).

The CPU 210 of the distribution apparatus 200 specifies the resource distribution information including the distribution ID (T2011) corresponding to the distribution instruction identifying information (T3011) indicated in each of the received installation result reports by referring to the resource distribution DB (T201).

The CPU 210 determines whether authentication has successfully been performed (S205) on the basis of the confirmation password (T2015) indicated in the specified resource distribution information and the password (T3014) indicated in the received installation result report.

If the received password matches the confirmation password (T2015) in the resource distribution information, the CPU 210 of the distribution apparatus 200 can determine that the authentication has successfully been performed (YES in operation S205).

On the other hand, if the received password does not match the confirmation password (T2015) in the resource distribution information, the CPU 210 of the distribution apparatus 200 can determine that the authentication has not successfully been performed (NO in operation S205).

If it is determined in operation S205 that the authentication has successfully been performed (YES in operation S205), the CPU 210 updates the installation result (T2016) in the resource distribution information on the basis of the received installation result report.

The CPU 210 registers the terminal identifying information (T3012) indicated in the installation result reports received in the above-described operation S204 and the installation result (T3015) indicated in the installation result reports in the installation result (T2016) of the resource distribution information.

Alternatively, on the basis of the installation result (T3015) indicated in the received installation result reports, the number of terminal apparatuses that have transmitted an installation result report indicating that installation has successfully been performed and/or the number of terminal apparatuses that have transmitted an installation result report indicating that installation has not successfully been performed may be registered as the installation result (T2016) in the resource distribution information.

FIG. 7 illustrates an example of content of the installation result (T2016) in the resource distribution information.

In the example illustrated in FIG. 7, “terminal A: OK” indicating that installation of the resource has successfully been performed in “terminal A” (terminal apparatus A) is registered as the installation result (T2016). Also, “terminal B: NG” indicating that installation of the resource has not successfully been performed in “terminal B” (terminal apparatus B) is registered as the installation result (T2016).

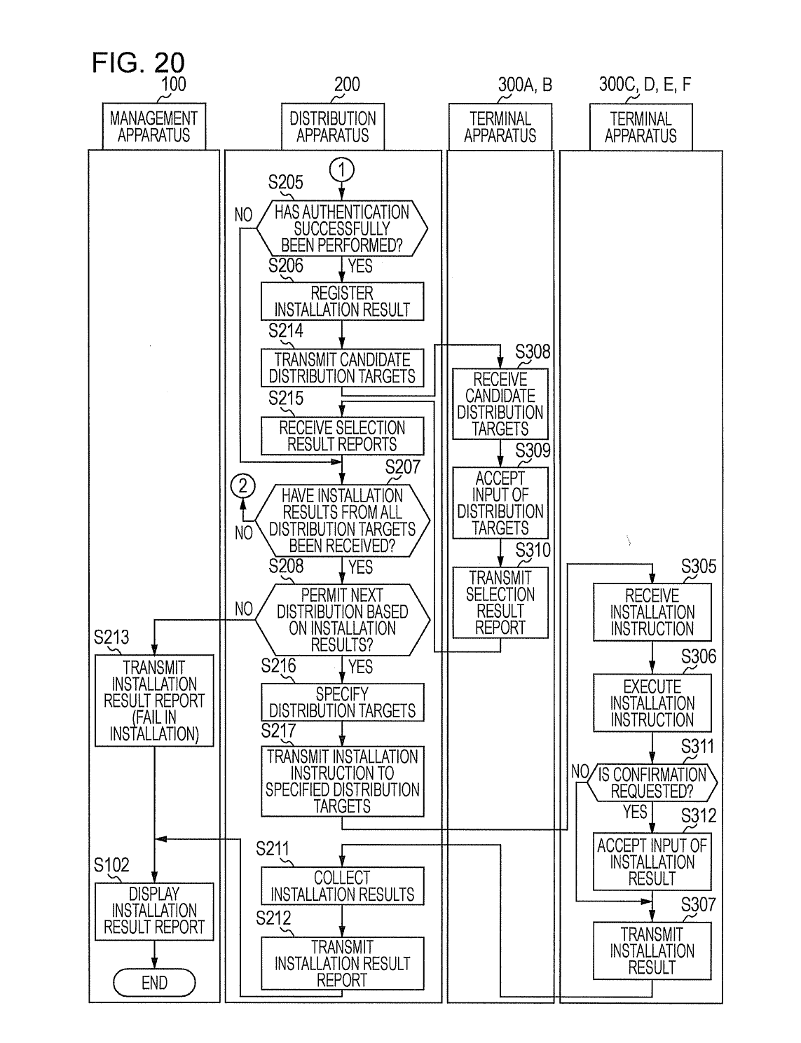

After the above-described operation S206 (FIG. 20) or if it is determined in operation S205 that authentication has not successfully been performed (NO in operation S205), the CPU 210 determines whether installation results from all the terminal apparatuses as distribution targets have been received (S207).

If it is determined in operation S205 that authentication has not successfully been performed (NO in operation S205), operation S206 is not performed in order to prevent the reference to the installation result in the following determining process because the installation result can be an installation result transmitted by a wrong operation by a user other than the maintenance worker.

If it is determined in operation S205 that the authentication has not successfully been performed (NO in operation S205), the CPU 210 may transmit a control signal for requesting a re-input of an installation result to the terminal apparatus 300 that has transmitted the installation result by using the communication unit 240.

Accordingly, the terminal apparatus 300 that has received the control signal is allowed to display the input screen illustrated in FIG. 14 again, whereby the maintenance worker is allowed to input and transmit an installation result. As a result, the distribution apparatus 200 can collect highly-reliable installation results from the maintenance worker.

If the installation result reports received from all the terminal apparatuses as distribution targets specified in the above-described operation S202 (distribution-target terminals) have been registered in the installation result (T2016) of the resource distribution information, the CPU 210 determines that installation results from all the distribution targets have been received (YES in operation S207).

If the CPU 210 determines that installation result reports from all the distribution targets have been received (YES in operation S207), the CPU 210 determines whether distribution of the resource to other terminal apparatuses should be permitted by referring to the installation result (T2016) of the resource distribution information (S208).

If the CPU 210 determines that distribution of the resource to other terminal apparatuses can be permitted (YES in operation S208), the CPU 210 specifies distribution targets in the next stage (S209) and transmits an installation instruction to the specified distribution targets as in the above-described operation S203.

Note that the installation instruction may include a control signal that does not request an input of an installation result by the maintenance worker in the terminal apparatus.

Accordingly, a confirmation work by the maintenance worker can be omitted.

A certain degree of confirmation of installation results can be performed in the execution of the installation instruction in the above-described operation S302 (FIG. 11), and thus it is highly possible that the same result can be obtained from other terminal apparatuses.

Each of the terminal apparatuses 300 receives the installation instruction transmitted from the distribution apparatus 200 connected via the network 400 (S305) (FIG. 20), executes the received installation instruction (S306), and transmits an installation result (S307).

Here, the installation result is not input by the maintenance worker but may be an execution result of the execution process in the above-described operation S306.

The terminal apparatus 300 can transmit, as an installation result, information indicating whether the execution process of the installation instruction has normally been completed.

The distribution apparatus 200 collects the installation results transmitted from the terminal apparatuses 300 connected via the network 400 (S211) and transmits the collected installation results to the management apparatus 100 (S212) (FIG. 20).

On the other hand, if it is determined in operation S208 that distribution of the resource to other terminal apparatuses is not permitted (NO in operation S208), an installation result report indicating that installation has not successfully been performed is transmitted to the management apparatus 100 (S213).

FIG. 18 illustrates a data structure of an installation result report such as transmitted from the distribution apparatus 200.

The installation result report illustrated in FIG. 18 includes distribution instruction identifying information (T2041), the number of lists (T2042), and pairs of terminal identifying information (T2043) and installation result (T2044), the numbers of the pairs being indicated in the number of lists (T2042).

The distribution instruction identifying information (T2041) illustrated in FIG. 18 corresponds to the distribution ID (T2011) of the resource distribution information registered in the resource distribution DB (T201).

The number of lists (T2042) illustrated in FIG. 18 indicates the number of pairs of the terminal identifying information (T2043) and the installation result (T2044) included in the installation result report.

The pairs of the terminal identifying information (T2043) and the installation result (T2044) illustrated in FIG. 18 correspond to the installation result (T2016) of the resource distribution information registered in the resource distribution DB (T201).

The management apparatus 100 receives the installation result report transmitted from the distribution apparatus 200 connected via the network 400 and displays the report in the display unit (S102).

The flow of the process in the entire system according to an embodiment of the present invention has been described.

Next, details of operation S208 illustrated in FIG. 12 are described.

In operation S208, the CPU 210 determines whether distribution of the resource to other terminal apparatuses should be permitted by referring to the installation result (T2016) of the resource distribution information registered in the resource distribution DB (S208).

In the installation result (T2016) of the resource distribution information, the installation result reports received in the above-described operation S204 are registered.

In the example illustrated in FIG. 7, “terminals A and B” (terminal apparatuses A and B) are registered as the distribution target (T2014) specified in the above-described operation S202.

Also, as the installation result (T2016), “terminal A: OK” indicating that installation of the resource has successfully been performed in “terminal A” (terminal apparatus A) is registered. Also, “terminal B: NG” indicating that installation of the resource has not successfully been performed in “terminal B” (terminal apparatus B) is registered.

For example, a higher importance may be put on eliminating an abnormal operation that can be caused by installing a resource than an effect obtained by installing the resource.

In this case, in the example illustrated in FIG. 7, an installation result indicating that installation has not successfully been performed is transmitted from the terminal apparatus B, so that the CPU 210 determines that permission for installation of the resource to other terminal apparatuses is not granted.

That is, the CPU 210 can determine to permit installation of the resource to other terminal apparatuses when the CPU 210 determines to have received installation result reports including the installation result (T3015) indicating that installation has successfully been performed from all the terminal apparatuses to which the installation instruction was transmitted in the above-described operation S203, by referring to the installation result (T2016) of the resource distribution information.

Otherwise, the CPU 210 can determine not to permit installation of the resource before receiving installation results from other terminal apparatuses when the installation result (T3015) in any of the installation result reports received in the above-described operation S204 (FIG. 11) indicates that installation has not successfully been performed, by referring to the installation result (T3015).

On the other hand, a higher importance may be put on an effect obtained by installing a resource than eliminating an abnormal operation that can be caused by installing the resource.

In this case, in the example illustrated in FIG. 7, an installation result report including an installation result indicating that installation has successfully been performed is transmitted from the terminal apparatus A, so that the CPU 210 can determine to permit installation of the resource to other terminal apparatuses.

For example, in the case where the resource to be installed is vaccine software for emergency countermeasures against computer virus or improvement software for emergency countermeasures to prevent unauthorized accesses, damages may occur due to infection with computer virus or unauthorized accesses if the resource is not installed.

Therefore, in such a case where the degree of risk is high, even if installation has not successfully been performed in part of terminal apparatuses but if installation has successfully been performed in the other terminals, installation of the resource to all the other terminals may be executed.

In such a case, the CPU 210 can determine to permit installation of the resource to other terminal apparatuses if the CPU 210 determines to have received an installation result indicating that installation has successfully been performed from any of the terminal apparatuses as destinations of the installation instruction in the above-described operation S203 (FIG. 11), by referring to the installation result (T2016) of the resource distribution information.

Alternatively, the CPU 210 can determine to permit installation of the resource before receiving an installation result from other terminal apparatuses if the installation result (T3015) of the installation result reports received in the above-described operation S204 indicates that installation has successfully been performed, by referring to the installation result (T3015).

Also, the CPU 210 can determine to permit installation of the resource to other terminal apparatuses if the CPU 210 determines that there exist a predetermined number or more of installation results indicating that installation has successfully been performed received from the terminal apparatuses to which the installation instruction was transmitted in operation S203, by referring to the installation result (T2016) of the resource distribution information.

For example, if an installation result indicating that installation has successfully been performed is received from 50% or more of the terminal apparatuses to which the installation instruction was transmitted in operation S203, the CPU 210 can determine to permit installation of the resource to other terminal apparatuses.

In the above-described determining process, switching may be performed on the basis of the installation instruction transmitted from the management apparatus 100 between a determination made by putting a higher importance on an effect obtained by installing the resource and a determination made by putting a higher importance on eliminating an abnormal operation that can be caused by installing the resource.

For example, in the distribution instruction inputting unit 101 of the management apparatus 100, an input field for inputting a control signal for selecting any of the above-described determination(s) may be provided, and the input control signal may be transmitted as an information element of the distribution instruction to the distribution apparatus 200.

In the above-described configuration, in the case where the control signal included in the distribution instruction indicates a determination made by putting a higher importance on an effect obtained by applying the resource, the CPU 210 refers to the installation result received in operation S204, and can determine to permit installation of the resource before receiving an installation result from other terminal apparatuses if the installation result that has been referred to indicates that installation has successfully been performed.

On the other hand, in the case where the control signal included in the distribution instruction indicates a determination made by putting a higher importance on eliminating an abnormal operation that can be caused by applying the resource, the CPU 210 refers to the installation result received in operation S204, and can determine not to permit installation of the resource before receiving installation results from other terminal apparatuses if the installation result that has been referred to indicates that installation has not successfully been performed.

Next, details of operation S209 illustrated in FIG. 12 are described.

In operation S209, after it has been determined in operation S208 that installation of the resource to other terminal apparatuses is permitted, the CPU 210 specifies distribution targets in the next stage by referring to the candidate distribution target (T2013) and the distribution target (T2014) in the resource distribution information registered in the resource distribution DB (S209).

In the candidate distribution target (T2013) and the distribution target (T2014) in the resource distribution information, the data registered in the resource distribution DB in operation S201 on the basis of the distribution instruction received in operation S200 is set.

In the example illustrated in FIG. 7, “terminals A, B, C, D, E, and F”, that is, the terminal apparatuses A, B, C, D, E, and F, are registered as the candidate distribution target (T2013).

Also, “terminals A and B”, that is, the terminal apparatuses A and B, are registered as the distribution target (T2014).

The CPU 210 can specify, as the distribution targets in the next stage, all the terminal apparatuses indicated in the candidate distribution target (T2013) except the terminal apparatuses indicated in the distribution target (T2014).

Specifically, in the example illustrated in FIG. 7, the CPU 210 can specify the terminal apparatuses C, D, E, and F as distribution targets in the next stage.

Furthermore, the CPU 210 may narrow down the distribution targets on the basis of the installation result (T2016) indicated in the resource distribution information.

That is, the CPU 210 may refer to the installation result (T2016) indicated in the resource distribution information, specify the terminal apparatus that has transmitted an installation result indicating that installation has not successfully been performed, and eliminate a terminal apparatus having the same configuration as that of the specified terminal apparatus from the distribution targets.

A further description is given by using the examples illustrated in FIGS. 7 and 8.

First, assume that the CPU 210 refers to the installation result in the resource distribution information and specifies the terminal apparatus B as the terminal apparatus that has transmitted the installation result indicating that installation has not successfully been performed.

Also, assume that the CPU 210 specifies the terminal apparatus A as the terminal apparatus that has transmitted the installation result indicating that installation has successfully been performed.

The CPU 210 refers to the configuration information of the terminal apparatus B registered in the apparatus configuration DB (T202) and specifies the apparatus configuration of the terminal apparatus that has transmitted the installation result indicating that installation has not successfully been performed (first apparatus configuration).

Also, the CPU 210 refers to the configuration information of the terminal apparatus A registered in the apparatus configuration DB (T202) and specifies the apparatus configuration of the terminal apparatus that has transmitted the installation result indicating that installation has successfully been performed (second apparatus configuration).

The CPU 210 compares the first apparatus configuration with the second apparatus configuration and specifies a different item therebetween.

In the example illustrated in FIG. 8, the CPU 210 compares hardware configuration information (T2022) of the terminal apparatus B as the first apparatus configuration with hardware configuration information (T2022) of the terminal apparatus A as the second apparatus configuration.

As a result, the CPU 210 specifies a difference therebetween: the free space of the auxiliary storage device of the terminal apparatus A is 50 GB, whereas the free space of the auxiliary storage device of the terminal apparatus B is 80 MB.

Additionally, in the example illustrated in FIG. 8, the CPU 210 compares software configuration information (T2023) of the terminal apparatus B as the first apparatus configuration with software configuration information (T2023) of the terminal apparatus A as the second apparatus configuration.

As a result, the CPU 210 specifies a difference therebetween: the version of Soft 2 of the terminal apparatus A is “V02L20”, whereas the version of Soft 2 of the terminal apparatus B is “V01L01”.

Accordingly, the CPU 210 can eliminate, from the distribution targets, a terminal apparatus in which the value of “free space in auxiliary storage device” indicated in the hardware configuration information (T2022) is “80 MB” or less.

In addition, the CPU 210 can eliminate, from the distribution targets, a terminal apparatus in which the value of Soft 2 indicated in the software configuration information (T2023) is “V01L01”.

In the example illustrated in FIG. 8, the CPU 210 refers to the items in the hardware configuration information registered in the apparatus configuration DB (T202) and specifies the terminal apparatus E as a terminal apparatus in which the value of “free space in auxiliary storage device” indicated in the hardware configuration information (T2022) is “80 MB” or less.

In the example illustrated in FIG. 8, the CPU 210 refers to the item in the software configuration information registered in the apparatus configuration DB (T202) and specifies the terminal apparatus F as a terminal apparatus in which the value of Soft 2 indicated in the software configuration information (T2023) is “V01L01”.

As a result, in the example illustrated in FIG. 8, the CPU 210 can eliminate the terminal apparatuses E and F from the distribution targets in the next stage.

The CPU 210 may specify a terminal apparatus to be eliminated on the basis of only one of the hardware configuration information (T2022) and the software configuration information (T2023) in the information registered in the apparatus configuration DB (T202).

Also, an item that is not referred to may be provided in items of each piece of the configuration information.

That is, the CPU 210 may refer to “free space in auxiliary storage device” without referring to “CPU” and “main storage” in the items of the hardware configuration information (T2022).

The flow of narrowing down distribution targets has been described.

In an embodiment, an operation of selecting terminal apparatuses as distribution targets in the next stage is accepted in addition to accepting an input of an installation result in the terminal apparatus 300.

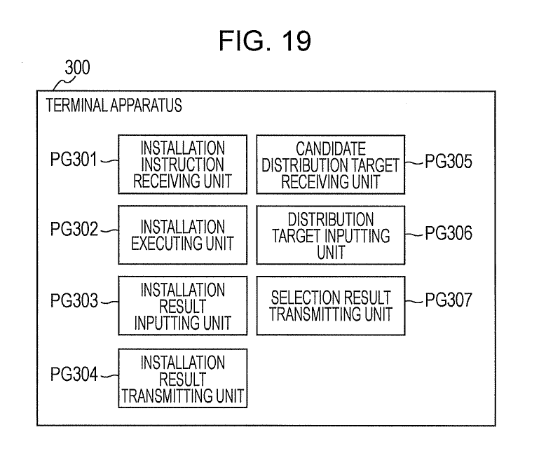

FIG. 19 illustrates a configuration of a program such as one executed by the terminal apparatus 300 according to an embodiment.

In the configuration of the program illustrated in FIG. 19, the same parts as those in the configuration of the program according to an embodiment (see FIG. 10) are denoted by the same reference numerals.

The configuration of the program illustrated in FIG. 19 is different from the configuration of the program executed by the terminal apparatus 300 according to an embodiment illustrated in FIG. 10 in that a candidate distribution target receiving unit PG305, a distribution target inputting unit PG306, and a selection result transmitting unit PG307 are provided.

The description about the same configuration is partly omitted for simplification.

The candidate distribution target receiving unit PG305 illustrated in FIG. 19 causes the CPU 310 to operate by serving as an element to receive candidate distribution targets transmitted from the distribution apparatus 200 by using the communication unit 340.

The distribution target inputting unit PG306 illustrated in FIG. 19 causes the CPU 310 to operate by serving as an element to accept an operation of selecting terminal apparatuses as next distribution targets from among the terminal apparatuses indicated in the candidate distribution targets received from the distribution apparatus 200.

The selection result transmitting unit PG307 illustrated in FIG. 19 causes the CPU 310 to operate by serving as an element to transmit a selection result, e.g., information identifying terminal apparatuses selected as next distribution targets, to the distribution apparatus 200 by using the communication unit 340.

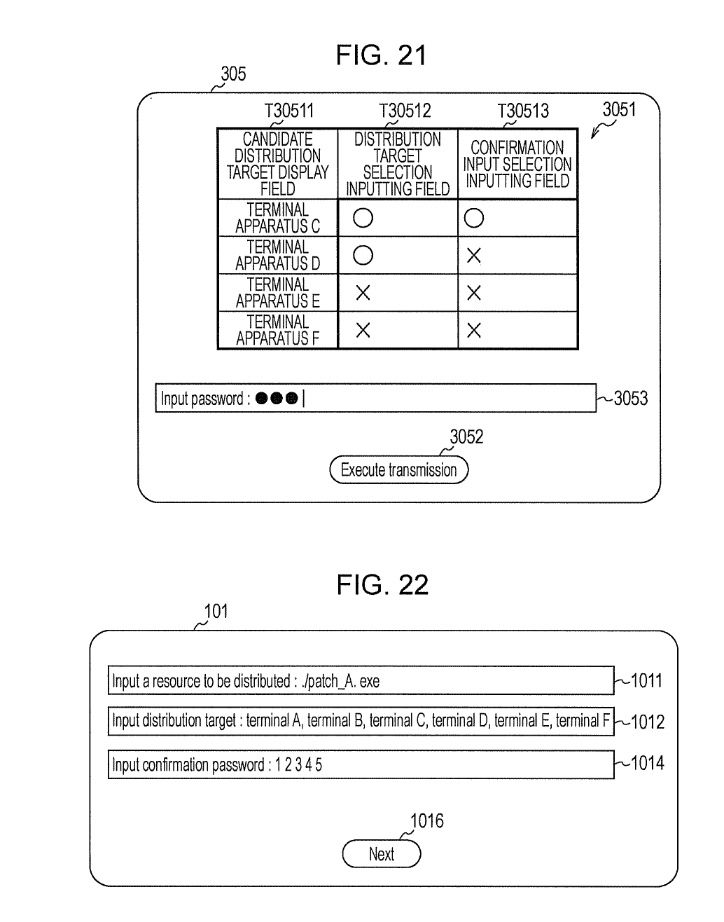

FIG. 21 illustrates an example of a screen of the distribution target inputting unit PG306 executed by the terminal apparatus according to an embodiment.

The example of the screen illustrated in FIG. 21 includes a selection inputting field 3051 including a candidate distribution target display field (T30511), a distribution target selection inputting field (T30512), and a confirmation input selection inputting field (T30513); a transmission execution button 3052 to provide instruction(s) to transmit input content; and a password inputting field 3053.

In the example illustrated in FIG. 21, a circle is input to the distribution target selection inputting field (T30512) for “terminal apparatus C” and “terminal apparatus D” in the candidate distribution target display field (T30511). This means that “terminal apparatus C” and “terminal apparatus D” are selected as distribution targets in the next stage.

In the example illustrated in FIG. 21, a circle is input to the confirmation input selection inputting field (T30513) for “terminal apparatus C” in the candidate distribution target display field (T30511). This means that a maintenance worker is requested to input an installation result in “terminal apparatus C” in the case where “terminal apparatus C” and “terminal apparatus D” are selected as distribution targets in the next stage.

In the example illustrated in FIG. 21, a cross is input to the distribution target selection inputting field (T30512) for “terminal apparatus E” and “terminal apparatus F” in the candidate distribution target display field (T30511). This means that “terminal apparatus E” and “terminal apparatus F” are not selected as distribution targets in the next stage.

In the example illustrated in FIG. 21, a cross is input to the confirmation input selection inputting field (T30513) for “terminal apparatus D”, “terminal apparatus E”, and “terminal apparatus F” in the candidate distribution target display field (T30511). This means that a maintenance worker is not requested to input an installation result in “terminal apparatus D”, “terminal apparatus E”, and “terminal apparatus F” in the case where “terminal apparatus D”, “terminal apparatus E”, and “terminal apparatus F” are selected as distribution targets in the next stage.

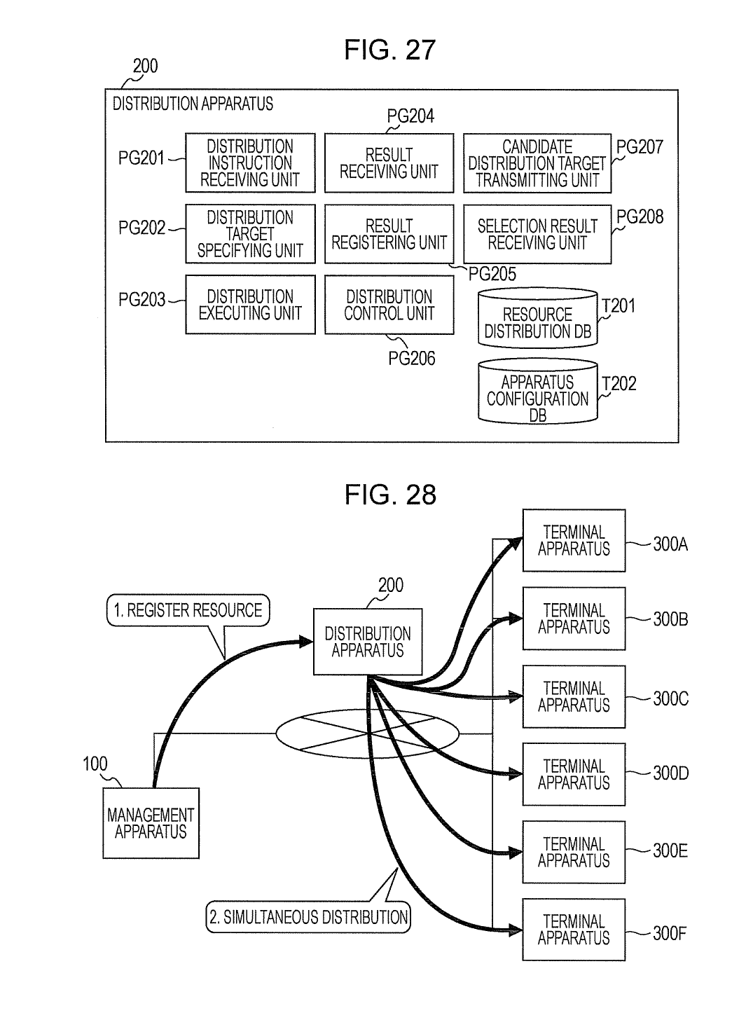

FIG. 27 illustrates a configuration of a program executed by the distribution apparatus 200 according to an embodiment.

In the configuration of the program illustrated in FIG. 27, the same parts as those of the configuration of the program according to an embodiment (see FIG. 5) are denoted by the same reference numerals.

The configuration of the program illustrated in FIG. 27 is different from the configuration of the program executed by the distribution apparatus 200 according to an embodiment illustrated in FIG. 5 in including a candidate distribution target transmitting unit PG207 and a selection result receiving unit PG208.

For simplifying the description, a description about the same configuration is partly omitted.

The candidate distribution target transmitting unit PG207 illustrated in FIG. 27 causes the CPU 210 to operate by serving as an element to transmit, to a terminal apparatus to which a software resource has been transmitted, a list of terminal apparatuses as candidate distribution targets to which the software resource has not been transmitted among the terminal apparatuses indicated by the terminal information included in the distribution instruction received from the management apparatus 100, by using the communication unit 240.

The selection result receiving unit PG208 illustrated in FIG. 27 causes the CPU 210 to operate by serving as an element to receive, from the terminal apparatus to which the list of candidate distribution targets has been transmitted, a selection result indicating a terminal apparatus as a next distribution target, by using the communication unit 240.

The distribution control unit PG206 illustrated in FIG. 27 causes the CPU 210 to operate by serving as an element to allow the distribution executing unit PG203 to distribute the software resource to the terminal apparatus indicated in the selection result received from the terminal apparatus.

FIG. 20 illustrates a flow of a process in the system according to an embodiment.

In the flow of the process in the system illustrated in FIG. 20, the same parts as those in the flow of the process in the system according to an embodiment (FIG. 12) are denoted by the same reference numerals.

The flow of the process in the system illustrated in FIG. 20 is different from the flow of the process in the system according to an embodiment illustrated in FIG. 12 in including operations S214 and S215 and operations S308 to S310.

The first half of the flow of the process in the system according to an embodiment is the same as that according to the embodiment illustrated in FIG. 11, and thus the description thereof is omitted.

Also, a description about the same part as the process procedure illustrated in FIG. 12 is partly omitted for simplifying the description.

First, if the CPU 210 of the distribution apparatus 200 has successfully authenticated a received installation result, (YES in operation S205), the CPU 210 specifies candidate distribution targets on the basis of the candidate distribution target (T2013) and the distribution target (T2014) in the resource distribution information and transmits the specified candidate distribution targets to the terminal apparatuses by using the communication unit 240 (S214).

For example, the CPU 210 specifies, as candidate distribution targets, the terminal apparatuses indicated in the candidate distribution target (T2013) in the resource distribution information except the terminal apparatuses indicated in the distribution target (T2014).

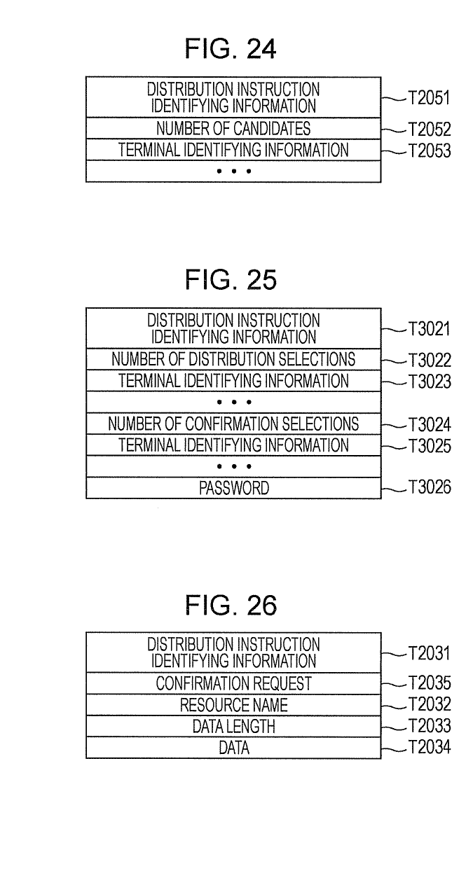

FIG. 24 illustrates a data structure of the candidate distribution target (T205) transmitted from the distribution apparatus 200.

The candidate distribution target illustrated in FIG. 24 includes distribution instruction identifying information (T2051), the number of candidates (T2052), and pieces of terminal identifying information (T2053) the number of which corresponds to the number of candidates (T2052).

The distribution instruction identifying information (T2051) illustrated in FIG. 24 corresponds to the distribution instruction identifying information (T2031) indicated in the installation instruction (T203) that is transmitted from the distribution apparatus 200 to the terminal apparatuses 300 in operation S210 in FIG. 12.

The number of candidates (T2052) illustrated in FIG. 24 indicates the number of terminal apparatuses indicated in the candidate distribution targets specified on the basis of the candidate distribution target (T2013) and the distribution target (T2014) in the resource distribution information.

The terminal identifying information (T2053) illustrated in FIG. 24 indicates information identifying the terminal apparatuses indicated in the above-described specified candidate distribution targets.

For example, an IP address of the terminal apparatus or a MAC address set in the communication unit 340 of the terminal apparatus can be used as the terminal identifying information (T2053).

Each of the terminal apparatuses 300 receives the candidate distribution targets transmitted from the distribution apparatus 200 connected via the network (S308) and accepts an input of distribution targets (S309).

FIG. 21 illustrates an example of an input screen including the distribution target selection inputting field (T30512) to receive “terminal apparatus C”, “terminal apparatus D”, “terminal apparatus E”, and “terminal apparatus F” as candidate distribution targets and input a result of selection as a distribution target.

Also, FIG. 21 illustrates an example of an input screen including the confirmation input selection inputting field (T30513) to input a request to a maintenance worker for a confirmation input in the case where “terminal apparatus C”, “terminal apparatus D”, “terminal apparatus E”, and “terminal apparatus F” are received as candidate distribution targets and selected as distribution targets.

The CPU 310 of the terminal apparatus 300 detects a press of the transmission execution button (3052) illustrated in FIG. 21 and transmits a selection result report (T302) indicating information of the terminal apparatuses specified as distribution targets on the basis of the input data to the distribution apparatus 200 by using the communication unit 340 (S310).

In the example illustrated in FIG. 21, a circle is input in the distribution target selection inputting field (T30512), so that “terminal apparatus C” and “terminal apparatus D” are specified as terminal apparatuses selected as distribution targets.

Additionally, the information of terminal apparatuses transmitted in operation S310 may include the data input to the confirmation input selection inputting field (T30513).

That is, information of “terminal apparatus C” selected as a distribution target may include information indicating requesting a confirmation input.

Also, information of “terminal apparatus D” selected as a distribution target may include information indicating not requesting a confirmation input.

FIG. 25 illustrates an example of a data structure of the selection result report (T302) transmitted from the terminal apparatus 300.

The selection result report illustrated in FIG. 25 includes distribution instruction identifying information (T3021), the number of distribution selections (T3022), pieces of terminal identifying information (T3023) the of which corresponds to the number of distribution selections (T3022), the number of confirmation selections (T3024), pieces of terminal identifying information (T3025) the number of which corresponds to the number of confirmation selections (T3024), and a password (T3026).

The distribution instruction identifying information (T3021) illustrated in FIG. 25 corresponds to the distribution instruction identifying information (T2051) indicated in the candidate distribution target (T205) received in operation S308.

The number of distribution selections (T3022) illustrated in FIG. 25 indicates the number of terminal apparatuses as distribution targets that were selected and input in operation S309.

In the example illustrated in FIG. 21, two circles are input in the distribution target selection inputting field (T30512), and thus the number of distribution selections “2”.

The terminal identifying information (T3023) illustrated in FIG. 25 indicates information identifying a terminal apparatus as a distribution target selected and input in operation S309.

For example, an IP address of the terminal apparatus or a MAC address set in the communication unit 340 in the terminal apparatus can be used as the terminal identifying information (T3023).

The number of confirmation selections (T3024) illustrated in FIG. 25 indicates the number of terminal apparatuses to be confirmed selected and input in operation S309.

In the example illustrated in FIG. 21, a circle is input in the confirmation input selection inputting field (T30513), and thus the number of confirmation selections (T3024) is “1”.

The terminal identifying information (T3025) illustrated in FIG. 25 indicates information identifying a terminal apparatus to be confirmed selected and input in operation S309.

For example, an IP address of the terminal apparatus or a MAC address set in the communication unit 340 in the terminal apparatus can be used as the terminal identifying information (T3025).

The password (T3026) illustrated in FIG. 25 corresponds to a value input to the password input field (3053) illustrated in FIG. 21.

The CPU 210 of the distribution apparatus 200 receives selection result reports transmitted from the respective terminal apparatuses 300 by using the communication unit 240 (S215).

In the same process procedure as that according to an embodiment, the CPU 210 determines whether installation results from all the distribution targets have been received (S207) and determines whether execution of next distribution can be permitted on the basis of the installation result (T2016) (S208).

As in operation S205, an authentication process of determining the validity of a received selection result report may be performed in operation S215.

In this case, the CPU 210 can perform the authentication process on the basis of the password (T3026) indicated in the selection result report and the confirmation password (T2015) in the resource distribution information registered in the resource distribution DB (T201).

If the selection result report is determined to have no validity as a result of the authentication process, the CPU 210 invalidates the received selection result report.

If The CPU 210 determines in operation S208 that execution of next distribution can be permitted (YES in operation S208), the CPU 210 specifies distribution targets on the basis of the information of the distribution targets received in operation S215 (S216).

In the example illustrated in FIG. 21, information indicating that “terminal apparatus C” and “terminal apparatus D” are selected as distribution targets is received in operation S215. Accordingly, the CPU 210 specifies “terminal apparatus C” and “terminal apparatus D” as distribution targets (S216).

Then, the CPU 210 transmits an installation instruction to the terminal apparatuses specified as distribution targets (S217), as in an embodiment.

In the case where information indicating whether a confirmation input is to be requested is received in operation S215, a control signal for requesting or not requesting a maintenance worker for a confirmation input of an installation result may be included in the installation instruction transmitted in operation S217 on the basis of the information (S217).

In the example illustrated in FIG. 21, information indicating that “terminal apparatus C” has been selected as a confirmation target is received in S215, and thus the CPU 210 specifies “terminal apparatus C” as a confirmation target.

In this case, the CPU 210 allows the installation instruction to be transmitted to “terminal apparatus C” to include a control signal for requesting a maintenance worker for a confirmation input of an installation result in the terminal apparatus.

On the other hand, the CPU 210 does not allow the installation instruction to be transmitted to “terminal apparatus D” to include a control signal for requesting a maintenance worker for a confirmation input of an installation result in the terminal apparatus.

FIG. 26 illustrates an example of a data structure of an installation instruction transmitted from the distribution apparatus 200.

The installation instruction illustrated in FIG. 26 includes distribution instruction identifying information (T2031), a confirmation request (T2035), a resource name (T2032), a data length (T2033), and data (T2034).

The distribution instruction identifying information (T2031) illustrated in FIG. 26 is information identifying a distribution instruction received from the management apparatus 100 and corresponds to the distribution instruction identifying information (T1011) indicated in the distribution instruction received from the management apparatus 100 in operation S200 in FIG. 11, for example.

The confirmation request (T2035) illustrated in FIG. 26 indicates a control signal for requesting or not requesting a maintenance worker for a confirmation input of an installation result in the terminal apparatus.

The resource name (T2032) illustrated in FIG. 26 corresponds to the resource name (T2012) included in the resource distribution information registered in the resource distribution DB (T201).

The data length (T2033) illustrated in FIG. 26 indicates the data length of a resource file stored in the storage area of the nonvolatile storage medium 280 specified by the resource name (T2012).

The data (T2034) illustrated in FIG. 26 indicates the data of the resource file stored in the storage area of the nonvolatile storage medium 280 specified by the resource name (T2012).

The terminal apparatus 300 that has received the installation instruction from the distribution apparatus 200 performs control to request or not request an input of an installation result in accordance with the presence/absence of the control signal for a confirmation request.

That is, the CPU 310 of the terminal apparatus 300 refers to the confirmation request (T2035) indicated in the received installation instruction, accepts an input of an installation result (S312) if it is determined that the control signal for requesting an input of an installation result is included (YES in S311) as in operation S303 illustrated in FIG. 11, and transmits the input installation result to the distribution apparatus 200 by using the communication unit 340 (S307).

On the other hand, if the CPU 310 determines that the control signal for requesting an input of an installation result is not included in the received installation instruction (NO in operation S311), the CPU 310 transmits the installation result to the distribution apparatus 200 without executing operation S312.

The same technical configuration as that of the distribution target inputting unit 305 included in the terminal apparatus 300 according to an embodiment can be applied to the management apparatus 100.

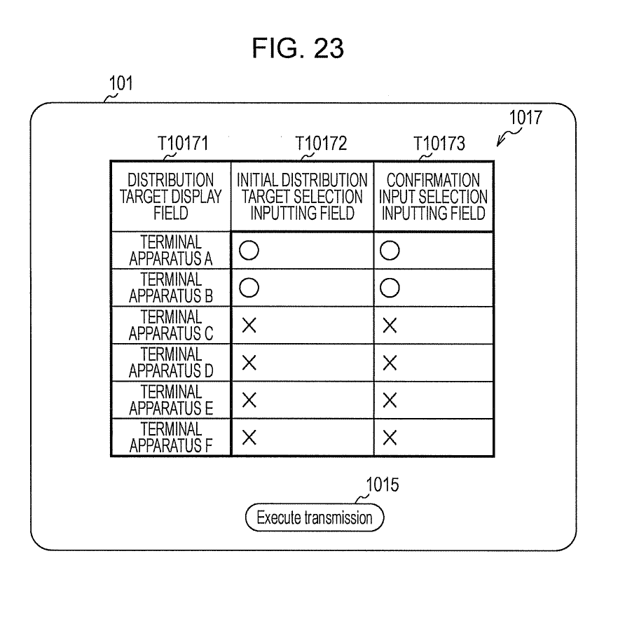

FIGS. 22 and 23 illustrate examples of a screen of the distribution instruction inputting unit 101 included in the management apparatus 100 in the case where the same technical configuration as that of the distribution target inputting unit 305 according to an embodiment is applied.

In the example illustrated in FIG. 22, “terminal apparatus A”, “terminal apparatus B”, “terminal apparatus C”, “terminal apparatus D”, “terminal apparatus E”, and “terminal apparatus F” are input as distribution targets.

FIG. 23 illustrates an example of the input screen that is displayed upon press of a “next” button 1016 illustrated in FIG. 22. In this example, “terminal apparatus A” and “terminal apparatus B” are selected in an initial distribution target selection inputting field (T10172) that indicates distribution targets of a resource in an initial distribution stage among the distribution targets input in the input screen illustrated in FIG. 22.

Furthermore, FIG. 23 illustrates an example where a request for a confirmation input of an installation result is input for “terminal apparatus A” and “terminal apparatus B” (T10173).

A system and method is provided including distributing a resource to a selected range of terminal apparatuses as specified by an instruction and selectively controlling distribution of the resource to a remaining of the terminal apparatuses based on information resulting subsequent to distribution of the resource to the selected range terminal apparatuses.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A resource distribution system that distributes a software resource to terminal apparatuses, the resource distribution system comprising:
a distribution instruction receiving unit configured to receive a distribution instruction including resource information indicating the software resource to be distributed to the terminal apparatuses and terminal information indicating the terminal apparatuses which are destinations of the resource;
a distribution target specifying unit configured to specify some of the terminal apparatuses indicated by the terminal information included in the distribution instruction received by the distribution instruction receiving unit, the some of the terminal apparatuses being specified as targets of distribution executed based on the resource information included in the distribution instruction;
a distribution executing unit configured to distribute the software resource indicated by the resource information included in the distribution instruction to the terminal apparatuses specified by the distribution target specifying unit;
a control information receiving unit configured to receive, from the terminal apparatuses to which the software resource has been distributed by the distribution executing unit, control information used to control the distribution of the software resource; and
a distribution control unit configured to make a determination whether distribution to other terminal apparatuses can be executed based on the received control information, allow the distribution target specifying unit to specify distribution targets among the terminal apparatuses indicated by the terminal information included in the distribution instruction when determining that distribution to other terminal apparatuses can be executed, and allow the distribution executing unit to distribute the software resource to the specified terminal apparatuses.

2. The resource distribution system according to claim 1,
wherein the control information receiving unit receives, when receiving the control information, authentication information indicating validity of the control information from the terminal apparatuses that transmit the control information, and
wherein the distribution control unit makes the determination by using control information the validity of which has been verified based on the received authentication information and does not use control information the validity of which has not been verified based on the received authentication information.

3. The resource distribution system according to claim 2,
wherein the distribution instruction received by the distribution instruction receiving unit includes authentication information that is used to verify the validity of the control information received by the control information receiving unit, and
wherein the distribution control unit compares the authentication information received by the control information receiving unit with the authentication information received by the distribution instruction receiving unit, and determines that the control information has validity when a comparison result satisfies a predetermined condition.

4. The resource distribution system according to claim 1,
wherein the control information received by the control information receiving unit includes an installation result including information about whether installation of the software resource has successfully been performed in the terminal apparatuses to which the software resource has been distributed by the distribution executing unit, and
wherein, when the number of pieces of the control information including an installation result indicating that installation of the resource has successfully been performed in the control information received by the control information receiving unit satisfies a predetermined condition, the distribution control unit determines that the software resource can be distributed to other terminal apparatuses.

5. The resource distribution system according to claim 4, comprising:
an apparatus configuration DB configured to store configuration information that includes hardware configuration information indicating information of hardware provided in terminal apparatuses and software configuration information indicating information of software provided in the terminal apparatuses, the configuration information being associated with terminal IDs identifying respective terminal apparatuses,
wherein the control information received by the control information receiving unit includes a terminal ID identifying the terminal apparatus that has transmitted the control information, and
wherein the distribution control unit
obtains, from the apparatus configuration DB, the configuration information associated with the terminal ID that is the same as the terminal ID included in the control information received by the control information receiving unit,
compares the configuration information associated with the terminal ID that is the same as the terminal ID included in the control information having an installation result indicating that installation of the software resource has not successfully been performed with the configuration information associated with the terminal ID that is the same as the terminal ID included in the control information having an installation result indicating that installation of the software resource has successfully been performed,
compares configuration information associated with another terminal apparatus stored in the apparatus configuration DB with a different item which is different from an item in the configuration information associated with the terminal apparatus that has succeeded in installation of the software resource among items in the configuration information associated with the terminal apparatus that has not succeeded in installation of the software resource obtained from a comparison result, and
eliminates the other terminal apparatus associated with the configuration information having an item that matches the different item from the targets of distribution executed by the distribution executing unit.

6. The resource distribution system according to claim 1, comprising:
a candidate distribution target transmitting unit configured to transmit, to the terminal apparatuses to which the resource has been distributed by the distribution executing unit, candidate distribution targets that indicate terminal apparatuses to which the software resource has not been distributed by the distribution executing unit among the terminal apparatuses indicated by the terminal information included in the received distribution instruction,
wherein the control information received by the control information receiving unit includes a selection result indicating terminal apparatuses as present distribution targets among the candidate distribution targets, and
wherein the distribution control unit allows the distribution executing unit to distribute the software resource to the terminal apparatuses indicated in the received selection result.

7. A computer-readable medium having a program stored therein that causes a computer to execute an operation including functioning as a distribution apparatus that distributes a software resource to terminal apparatuses, comprising:
receiving a distribution instruction including resource information indicating the software resource to be distributed to the terminal apparatuses and terminal information indicating the terminal apparatuses which are destinations of the resource;
specifying some of the terminal apparatuses indicated by the terminal information included in the received distribution instruction, the some of the terminal apparatuses being specified as targets of distribution executed based on the resource information included in the distribution instruction;
distributing the software resource indicated by the resource information included in the distribution instruction to the specified terminal apparatuses;
receiving, from the terminal apparatuses to which the software resource has been distributed, control information used to control the distribution of the software resource;
managing the received control information by associating the control information with the distribution instruction;
making a determination whether a distribution range is to be extended based on the managed control information; and
specifying distribution targets among the terminal apparatuses that are not specified in the specifying among the terminal apparatuses indicated by the terminal information included in the distribution instruction when determining that the distribution range can be extended, and distributing the software resource to the specified terminal apparatuses.

8. The computer-readable medium according to claim 7, comprising:
receiving, in the receiving of the control information, control information including authentication information indicating validity of the control information; and
determining, by using control information the validity of which has been verified based on the received authentication information, and not using control information the validity of which has not been verified based on the received authentication information.

9. The computer-readable medium according to claim 8, comprising:
receiving, in the receiving of the distribution instruction, the distribution instruction including authentication information that is used to verify the validity; and
comparing the authentication information in the control information with the authentication information in the distribution instruction, and determining that the control information has validity when a comparison result satisfies a predetermined condition.

10. The computer-readable medium according to claim 7,
wherein the received control information includes an installation result including information about whether installation of the software resource has successfully been performed in the terminal apparatuses to which the software resource has been distributed in the distributing, and
wherein the program causes the computer functioning as the distribution apparatus to execute:
determining that a distribution range of the software resource can be extended when the number of pieces of the control information including an installation result indicating that installation of the resource has successfully been performed in the received control information satisfies a predetermined condition in the determination of extension of the distribution range.

11. The computer-readable medium according to claim 10,
wherein the received control information includes a terminal ID identifying the terminal apparatus that has transmitted the control information, and
wherein the program causes the computer functioning as the distribution apparatus to execute:
obtaining, from an apparatus configuration DB configured to store configuration information that includes hardware configuration information indicating information of hardware provided in terminal apparatuses and software configuration information indicating information of software provided in the terminal apparatuses, the configuration information being associated with terminal IDs identifying respective terminal apparatuses, the configuration information associated with the terminal ID that is the same as the terminal ID included in the received control information;
comparing the configuration information associated with the terminal ID that is the same as the terminal ID included in the control information having an installation result indicating that installation of the software resource has not successfully been performed with the configuration information associated with the terminal ID that is the same as the terminal ID included in the control information having an installation result indicating that installation of the software resource has successfully been performed;
comparing configuration information associated with another terminal apparatus stored in the apparatus configuration DB with a different item which is different from an item in the configuration information associated with the terminal apparatus that has succeeded in installation of the software resource among items in the configuration information associated with the terminal apparatus that has not succeeded in installation of the software resource obtained from a comparison result; and
eliminating the other terminal apparatus associated with the configuration information having an item that matches the different item from the targets of distribution in the determination of extension of the distribution range.

12. The computer-readable medium according to claim 7, comprising:
transmitting, to the terminal apparatuses to which the software resource has been distributed, candidate distribution targets that indicate terminal apparatuses to which the software resource has not been distributed among the terminal apparatuses indicated by the terminal information included in the received distribution instruction,
the received control information including a selection result indicating terminal apparatuses as present distribution targets among the candidate distribution targets; and
distributing the software resource to the terminal apparatuses indicated in the received selection result.

13. A resource distribution method used in a computer functioning as a distribution apparatus that distributes a software resource to terminal apparatus, the resource distribution method comprising:
receiving a distribution instruction including resource information indicating the software resource to be distributed to the terminal apparatuses and terminal information indicating the terminal apparatuses which are destinations of the resource;
specifying some of the terminal apparatuses indicated by the terminal information included in the received distribution instruction, the some of the terminal apparatuses being specified as targets of distribution executed based on the resource information included in the distribution instruction;
distributing the software resource indicated by the resource information included in the distribution instruction to the specified terminal apparatuses;
receiving, from the terminal apparatuses to which the software resource has been distributed, control information used to control the distribution of the software resource;
managing the received control information by associating the control information with the distribution instruction;
making a determination whether a distribution range can be extended based on the managed control information; and
specifying distribution targets among the terminal apparatuses that are not specified in the specifying among the terminal apparatuses indicated by the terminal information included in the distribution instruction when determining that the distribution range can be extended, and distributing the software resource to the specified terminal apparatuses.

14. The resource distribution method according to claim 13,
wherein the receiving of the control information receives control information including authentication information indicating validity of the control information, and
wherein the determination is made by using control information the validity of which has been verified based on the received authentication information, and control information the validity of which has not been verified based on the received authentication information is not used.

15. The resource distribution method according to claim 14,
wherein the receiving of the distribution instruction receives the distribution instruction including authentication information that is used to verify the validity, and
wherein the authentication information in the control information is compared with the authentication information in the distribution instruction, and a determination is made that the control information has validity when a comparison result satisfies a predetermined condition.

16. The resource distribution method according to claim 13,
wherein the received control information includes an installation result including information about whether installation of the software resource has successfully been performed in the terminal apparatuses to which the software resource has been distributed in the distributing, and
wherein, when the number of pieces of the control information including an installation result indicating that installation of the resource has successfully been performed in the received control information satisfies a predetermined condition, determining that the distribution range of the software resource can be extended in the determination.

17. The resource distribution method according to claim 16,
wherein the received control information includes a terminal ID identifying the terminal apparatus that has transmitted the control information,
wherein, from an apparatus configuration DB configured to store configuration information that includes hardware configuration information indicating information of hardware provided in terminal apparatuses and software configuration information indicating information of software provided in the terminal apparatuses, the configuration information being associated with terminal IDs identifying respective terminal apparatuses, the configuration information associated with the terminal ID that is the same as the terminal ID included in the received control information is obtained,
wherein the configuration information associated with the terminal ID that is the same as the terminal ID included in the control information having an installation result indicating that installation of the software resource has not successfully been performed is compared with the configuration information associated with the terminal ID that is the same as the terminal ID included in the control information having an installation result indicating that installation of the software resource has successfully been performed,
wherein configuration information associated with another terminal apparatus stored in the apparatus configuration DB is compared with a different item which is different from an item in the configuration information associated with the terminal apparatus that has succeeded in installation of the software resource among items in the configuration information associated with the terminal apparatus that has not succeeded in installation of the software resource obtained from a comparison result, and
wherein the other terminal apparatus associated with the configuration information having an item that matches the different item is eliminated from the targets of distribution in the determination of extension of the distribution range.

18. The resource distribution method according to claim 13,
wherein candidate distribution targets that indicate terminal apparatuses to which the software resource has not been distributed among the terminal apparatuses indicated by the terminal information included in the received distribution instruction are transmitted to the terminal apparatuses to which the software resource has been distributed,
wherein the received control information includes a selection result indicating terminal apparatuses as present distribution targets among the candidate distribution targets, and
wherein the software resource is distributed to the terminal apparatuses indicated in the received selection result.

19. A computer-readable medium having a program stored therein that causes a computer to execute an operation including functioning as a terminal apparatus that installs a software resource distributed by a distribution apparatus, comprising:
receiving a software resource distributed by a distribution apparatus;
installing the received software resource;
requesting an operator of the terminal apparatus to input information used to control distribution of the resource after completing the installing; and
transmitting the input information to the distribution apparatus.

20. The computer-readable medium according to claim 19, comprising:
requesting an input of information indicating whether the installing of the resource has successfully been performed when requesting the operator of the terminal apparatus to input information.

21. The computer-readable medium according to claim 19, comprising:
receiving a list of terminal apparatuses from the distribution apparatus; and
requesting the operator to select terminal apparatuses as next distribution targets from the received list of terminal apparatuses when requesting the operator of the terminal apparatus to input information.

22. The computer-readable medium according to claim 19, comprising:
requesting the operator to input a password that is used in authentication in the distribution apparatus when requesting the operator of the terminal apparatus to input information.

23. A computer-implemented method, comprising:
distributing a resource to a selected range of terminal apparatuses as specified by an instruction; and
controlling distribution of the resource to a remaining of the terminal apparatuses based on information resulting subsequent to distribution of the resource to the selected range terminal apparatuses.
